(19) United States
(12) Patent Application Publication
(10) Pub. No.: US 2024/0228793 A1
(43) Pub. Date: Jul. 11, 2024

(54) POWDER COATING COMPOSITION BLEND

(71) Applicant: Allnex Netherlands B.V., Bergen Op Zoom (NL)

(72) Inventors: Pengcheng YANG, Arnhem (NL); Richard Hendrikus Gerrit BRINKHUIS, Zwolle (NL); Rong XIONG, Shanghai (CN); Alessandro MINESSO, Morgano (IT)

(73) Assignee: Allnex Netherlands B.V., Bergen Op Zoom (NL)

(21) Appl. No.: 18/288,458

(22) PCT Filed: May 6, 2022
(86) PCT No.: PCT/EP2022/062327

§ 371 Date: Oct. 26, 2023

(30) Foreign Application Priority Data
May 10, 2021 (WO) PCT/CN2021/092543

(51) Int. Cl. C09D 5/03; C09D 7/61; C09D 7/80; C09D 163/10; C09D 167/07

(52) U.S. Cl. CPC C09D 5/033; C09D 7/61; C09D 7/80; C09D 163/10; C09D 167/07

(57) ABSTRACT

A powder coating composition blend comprising a crosslinkable composition and a catalyst system, wherein the crosslinkable composition is formed by a crosslinkable donor component A and a crosslinkable acceptor component B that are crosslinkable by a Real Michael Addition (RMA) reaction via the catalyst system, wherein the catalyst system is a separated catalyst system that comprises a catalyst precursor composition (P) and a catalyst activator composition (C) that are macrophysically separated; or wherein the crosslinkable donor component A and the crosslinkable acceptor component B are macrophysically separated.

### BACKGROUND OF THE INVENTION

The invention relates to a powder coating composition blend comprising a crosslinkable composition that is crosslinkable via Real Michael Addition (RMA) and a catalyst system that catalyzes the RMA, a process for coating articles using said powder coating composition blend and the coated articles.

### DESCRIPTION OF THE RELATED ART

Powder coatings are dry, finely divided, free flowing, solid materials at room temperature and have gained popularity in recent years over liquid coatings. Powder coatings are generally cured at elevated temperatures between 120° C. and 200° C., more typically between 140° C. and 180° C. High temperatures are required to provide for sufficient flow of the binder to allow film formation and achieve good coating surface appearance, but also for achieving high reactivity for a crosslinking reaction. At low curing temperatures, one may face reaction kinetics that will not allow short cure times when demanding full mechanical and resistance property development; on the other hand, for systems where a high reactivity of the components may be created, the coatings likely have a poor appearance due to the relatively high viscosity of such systems at such lower temperatures, rapidly increasing further as the cure reaction proceeds: the time-integrated fluidity of such systems is too low to achieve sufficient leveling (see e.g. Progress in Organic Coatings, 72 page 26-33 (2011)). Especially when targeting thinner films, appearance may be limiting. Moreover, very high reactivities may lead to problems due to premature reaction when formulating powder paints in an extruder. In addition, highly reactive formulations may have a limited storage stability.

Many powder coating compositions provide coatings having a high gloss after curing. There is an increasing demand for powdered paints and resins which provides coating having a good quality and showing a reduced gloss. Furthermore, it is an advantage if such type of coatings can be applied on heat-sensitive substrates such as medium density fibre-board (MDF), wood, plastics and certain metal alloys.

Patent application WO 2019/145472 describes a powder coating composition that provides a glossy coating on substrates that are heat-sensitive substrates such as medium density fibre-board (MDF), wood, plastics and certain metal alloys and is able to cure at low temperature with a high curing speed and acceptable short curing times, whereby the curing time remains sufficiently long open to allow flow and coalescence and achieve good film formation with good coating appearances. This coating composition is curable via RMA using a catalyst system that facilitates the RMA reaction.

Powder coating compositions based on this system can still suffer from premature reaction upon prolonged storage. Therefore there is a need for a powder coating composition having good properties that can cure at low temperatures with a high curing speed, that provides a matt coating and ensures a long shelf life upon storage.

### BRIEF SUMMARY OF THE INVENTION

Present invention addresses one or more of the above problems by providing a powder coating composition blend as described in claim 1.

Accordingly a first aspect of the invention is related to a powder coating composition blend comprising a crosslinkable composition and a catalyst system, wherein the crosslinkable composition is formed by a crosslinkable donor component A and a crosslinkable acceptor component B that are crosslinkable by a Real Michael Addition (RMA) reaction via the catalyst system, and which catalyst system is able to catalyze the RMA crosslinking reaction at a curing temperature below 200° C., preferably below 175° C., more preferably below 150° C., 140, 130 or even 120° C. and preferably at least 70° C., preferably at least 80, 90 or 100° C.,

wherein the crosslinkable composition comprises
a) the crosslinkable donor component A having at least 2 acidic C—H donor groups in activated methylene or methine, and
b) the crosslinkable acceptor component B having at least 2 activated unsaturated acceptor groups C═C, which react with component A by Real Michael Addition (RMA) to form a crosslinked network,

and

wherein the catalyst system is a separated catalyst system that comprises a catalyst precursor composition (P) and a catalyst activator composition (C) that are macrophysically separated; wherein
the catalyst precursor composition (P) comprises a catalyst precursor P1; and
the catalyst activator composition (C) comprises a catalyst activator C1;

or

wherein the crosslinkable donor component A and the crosslinkable acceptor component B are macrophysically separated; and the catalyst system is
a latent catalyst system comprising the catalyst precursor P1 and the catalyst activator C1; or
non-latent catalyst system comprising a strong base;

wherein the catalyst precursor P1 is a weak base with a pKa of its protonated form of more than 2, preferably more than 3, more preferably more than 4 and even more preferably at least 5 units lower than that of the activated C—H groups in donor component A; and the catalyst activator C1 can react with P1 at curing temperature, producing a strong base (C1P1) that can catalyze the Michael Addition reaction between A and B.

In a second aspect, the invention is related to a method for powder-coating a substrate comprising
applying a layer comprising a powder coating composition blend according to the first aspect to a substrate surface wherein the substrate preferably is a temperature sensitive substrate, preferably MDF, wood, plastic, composite or temperature sensitive metal substrates like alloys; and
heating to a curing temperature Tour between 75 and 200° C., preferably between 80 and 180° C. and more preferably between 80 and 160, 150, 140, 130 or even 120° C., preferably using infrared heating, wherein the melt viscosity at the curing temperature Tour is preferably less than 60 Pas, more preferably less than 40, 30, 20, 10 or even 5 Pas; and
curing at Tour for a curing time preferably less than 40, 30, 20, 15, 10 or even 5 minutes.

In a third aspect the invention is related to articles coated with a powder having a powder coating composition blend according to the first aspect, wherein the articles preferably have a temperature sensitive substrate preferably selected from the group of MDF, wood, plastic or metal alloys and wherein preferably the crosslinking density XLD is at least 0.01, preferably at least 0.02, 0.04, 0.07 or even 0.1 mmole/ml (as determined by dynamical mechanical thermal analysis (DMTA)) and is preferably lower than 3, 2, 1.5, 1 or even 0.7 mmole/ml.

### DETAILED DESCRIPTION OF THE INVENTION

The inventors surprisingly found that a powder coating composition blend according to the invention whereby either the catalyst system or the crosslinkable components are macrophysically separated, provides a coating composition that can be cured at low temperature with high curing speed, that has a long shelf life and provides a coating with matt appearance.

According to the invention, the term “macrophysically separated” means that reactable compounds are essentially inaccessible for chemical reaction in the powder blend below curing temperature. This is because not all the reactable components of the powder coating composition blend are melt-mixed (also called extruded) together. In current invention either the crosslinkable components are macrophysically separated or the catalyst system is macrophysically separated.

In case the crosslinkable components are macrophysically separated, this means that the crosslinkable donor component A is not melt-mixed with the crosslinkable acceptor component B. In case the separated catalyst system is macrophysically separated, this means that the catalyst precursor composition (P) is not melt mixed with the catalyst activator composition (C).

The inventors found that when the components A and B or (P) and (C) are macrophysically separated, then it is possible to provide a powder blend that can be cured to form a powder coating having a good quality and having a matt appearance or a delustering appearance. Furthermore, since the components A and B or (P) and (C) are macrophysically separated, the likelihood that reactions take place during storage is much lower and thus a longer shelf life is obtained.

Furthermore the powder coating composition blend is also suitable for powder coatings that can be cured at low temperatures with a relatively high curing speed, acceptable short curing times and achieve good crosslinking with good coating appearance.

The powder coating composition blend according to the invention can be cured at curing temperature Tcur chosen between 75 and 200° C., preferably between 80 and 180° C. and more preferably between 100 and 160, 150, 140, 130 or even 120° C. and preferably also uses infrared heating. Preferably the melt viscosity at the curing temperature is less than 60 Pas, more preferably less than 40, 30, 20, 10 or even 5 Pas. The melt viscosity can e.g. be measured with a Brookfield CAP 2000 cone-and-plate rheometer according to ASTM D4287, using spindle #5 and is to be measured at the very onset of the reaction or on the powder coating composition blend without catalyst activity.

The low curing temperatures make it possible to use the powder coating composition blend for powder coating temperature sensitive substrates, preferably MDF, wood, plastic, composites or temperature sensitive metal substrates like alloys. The invention therefore also relates in particular to such articles coated with a powder coating composition blend according to the invention. It was found that good coating properties could be obtained with good crosslinking density XLD and resulting good coating properties.

### BRIEF DESCRIPTION OF THE FIGURES

Aspects of the invention will now be described in more detail. Reference is thereby made to the appended figures.

FIG. 1 describes the isothermal DSC plots for powder coating composition PW1 cured at 120° C., both when freshly prepared and upon storage at 35° C. for 5 days.

FIG. 2 describes the isothermal DSC plots for 50/50 blend of powder coating composition blends of PWC3A+PWC3B1 cured at 120° C., both when freshly prepared and upon storage at 35° C. for 30 days.

FIG. 3 describes the DSC temperature scan plots for 20/1 blend of PWC5A+PWC5B between 10-230° C., both when freshly prepared and upon storage at 35° C. for 30 days.

FIG. 4 describes the isothermal DSC plots for PW6 and PW8 at 100° C.

FIG. 5 describes the DSC temperature scan plots for PW6 and PW8 between −30-230° C.

### DESCRIPTION OF EMBODIMENTS

### Powder Coating Composition Blend

In one embodiment the powder coating composition blend is prepared by the steps of
melt-mixing components A and/or B of the crosslinkable composition with the catalyst precursor composition (P) and optionally a retarder T to obtain a precursor extrudate;
melt-mixing components A and/or B of the crosslinkable composition with the catalyst activator composition (C) and optionally the retarder T to obtain an activator extrudate;
solidifying and granulating the precursor extrudate and activator extrudate to obtain a precursor powder composition and an activator powder composition;
dry blending the precursor and activator powder compositions to obtain the powder coating composition blend.

In this embodiment, the separated catalyst compositions (P) and (C) are not melt-mixed (melt-mixing is also called extrusion). The precursor extrudate can comprise either one or both RMA crosslinkable component A and B. In case the precursor extrudate only comprises component A, than the activator extrudate comprises at least component B and vice versa.

In another embodiment the powder coating composition blend is prepared by
melt-mixing the crosslinkable component A to obtain a donor extrudate and/or melt-mixing the crosslinkable component B to obtain an acceptor extrudate, whereby the crosslinkable component A and/or B is melt-mixed with the latent or the non-latent catalyst system;
solidifying and granulating the donor and/or the acceptor extrudate to obtain a donor powder composition and/or an acceptor powder composition;
dry blending the donor powder composition and acceptor powder composition in case components A and B have been melt mixed; or dry blending the donor powder composition or the acceptor powder composition with a crosslinkable component B or A, respectively, that have a grindable solid form, in case only component A or B has been melt mixed to obtain the powder coating composition blend.

In one specific embodiment the powder coating composition blend comprises a catalyst activator composition (C) comprising
a catalyst activator residing on a carrier in case the catalyst activator C1 is liquid; In another specific embodiment the powder coating composition blend comprises a catalyst precursor composition (P) comprising
a catalyst precursor residing on a carrier in case the catalyst precursor P1 is liquid;

The carrier is a porous substance that can absorb liquids and is e.g. a silica carrier. Preferably, the particle size (defined as Dᵥ⁵⁰) of the carrier is between 5 and 200 μm, more preferably between 10 and 150 μm, even more preferably between 10 and 100 μm, or between 15 and 50 μm.

In such embodiments the powder coating composition blend can be prepared by
melt-mixing components A and B of the crosslinkable composition with the catalyst precursor composition (P) and optionally the retarder T to obtain a precursor extrudate;
solidifying and granulating the precursor extrudate to obtain a precursor powder composition;
dry blending the precursor powder composition with the catalyst activator residing on a carrier to obtain the powder coating composition blend; or
melt-mixing components A and B of the crosslinkable composition with the catalyst activator composition (C) and optionally the retarder T to obtain an activator extrudate;
solidifying and granulating the activator extrudate to obtain an activator powder composition;
dry blending the activator powder composition with a catalyst precursor residing on a carrier to obtain the powder coating composition blend.

According to this invention, for the melt-mixing (also called extrusion) standard processes can be used which are typically used for making powder resins. Thereby it is typical that after the extrudate is formed in an extruder, well known by a person skilled in the art, the extrudate is immediately solidified by force-spreading the extrudate onto a cooling band. The solidified extrudate can take the form of a solidified sheet as it travels along the cooling band. At the end of the band, the sheet is then granulated and thus broken up into small pieces, preferably via a peg breaker, to a powder composition. At this point, there is no significant shape control applied to the granules, although a statistical maximum size is preferred. The granulate can then be transferred to a classifying microniser, where it is further milled. The powder compositions are then blended to form the powder coating composition blend. It is also possible that the solidified sheets deriving from the precursor extrudate and the activator extrudate or the donor and acceptor extrudate are granulated, eventually micronized, and blended together. Since the catalyst precursor P1 and the catalyst activator D1 in one embodiment or the donor component A and acceptor component B in another embodiment are not extruded together they are macrophysically separated in the powder coating composition blend.

When the powder coating composition blend having macrophysically separated reactants (i.e. precursor P1 and activator C1 or donor component A and acceptor component B) is applied as powder coating, a powder layer will be formed on the substrate that will still have, at the onset of melting, a macrophysical separation of the complementary reactants. The progress of the cure reaction will depend on these complementary reactants diffusing together from this starting situation, and diffusion length and time required for this process will depend on the size details of the original powder blend, as well as the diffusion coefficients. The dimensions of compositional contrast of such a starting situation depends on the particle sizes of the individual particulate blend components and their volume ratio, when considered to form a random stack upon application. Diffusion length, and diffusion time required for overall good crosslinking performance, will be smaller when the particles used for blending are smaller; too large particles may lead to too large distances to be overcome during the curing step. Therefore, the powder compositions used for blending have preferably a particle size (defined as Dᵥ⁵⁰) of maximum 200 μm, more preferably maximum 150 μm, more preferable no more than 100 μm and most preferably less than 50 μm.

Dᵥ⁵⁰ is the particle size in microns at which 50% of the sample is smaller and 50% is larger. This value is also known as the Mass Median Diameter (MMD) or the median of the volume distribution.

The mass ratio of the different powder compositions in the powder coating composition blend may also play a role. In case the ratio is strongly asymmetric, effective diffusion length will be longer as the majority component will have less probability to be in direct contact with a complementary particle in the original particle stack. It is therefore preferred that the mass ratio (wt %/wt %) of the precursor powder composition and activator powder composition or the donor powder composition and acceptor powder composition used for dry blending is between 20 and 0.05, more preferably between 10 and 0.1, even more preferably between 5 and 0.2, or between 2 and 0.5. In general, more asymmetry can be tolerated if smaller particles are involved.

In case one of the components used for dry blending is a catalyst precursor or activator residing on a carrier then the component is preferably present in and amount of between 1 and 30 wt %, preferably between 3 and 20 wt %, more preferably between 4 and 15 wt % in view of the total powder composition blend.

The powder coating composition blend, may further comprise additives such as additives selected from the group of pigments, dyes, dispersants, degassing aids, levelling additives, matting additives, flame retarding additives, additives for improving film forming properties, for optical appearance of the coating, for improving mechanical properties, adhesion or for stability properties like colour and UV stability. These additives can be melt-mixed together with one or more of the components of the powder coating composition blend.

### The Separated Catalyst System

In one preferred embodiment, the catalyst system is a separated catalyst system that comprises the catalyst precursor composition (P) comprising a catalyst precursor P1 which is a weak base with a pKa of its protonated form of more than 2, preferably more than 3, more preferably more than 4 and even more preferably at least 5 points lower than that of the activated C—H donor groups in activated methylene or methine of crosslinkable donor component A; and the catalyst activator composition (C) comprising a catalyst activator C1 that at cure temperature can react with P1, producing a strong base (C1P1) able to initiate the Michael Addition reaction between A and B. The catalyst precursor composition (P) and the catalyst activator composition (C) are macrophysically separated.

Most preferably, the catalyst precursor composition (P) further comprises the crosslinkable donor composition A and/or the crosslinkable acceptor composition (B) and the catalyst activator composition (C) further comprises the crosslinkable donor composition A and/or the crosslinkable acceptor composition (B). Preferably the donor composition (A) and the acceptor composition (B) are present in the separated catalyst system in a way that they are melt-mixed together with the catalyst precursor P1 or the catalyst activator C1. It was surprisingly found that when the catalyst precursor P1 or the catalyst activator C1 are extruded with the crosslinkable donor composition A and/or the crosslinkable acceptor composition (B), the composition provides a powder coating with a lower gloss and a better MEK resistance compared to powder coating made from powder composition blends whereby the catalyst precursor P1 or the catalyst activator C1 is added as a separate compound to a blend of donor composition (A), acceptor composition (B), and the complementary component of the catalyst system (catalyst precursor P1 or the catalyst activator C1).

In one embodiment, the catalyst system comprises the catalyst activator composition (C) comprising activator C1 that is preferably selected from the group of epoxide, carbodiimide, oxetane, oxazoline or aziridine functional components, preferably an epoxide or carbodiimide, and comprise the catalyst precursor composition (P) comprising catalyst precursor P1 that is preferably a weak base nucleophile anion chosen from the group carboxylate, phosphonate, sulphonate, halogenide or phenolate anions or a non-ionic nucleophile, preferably a tertiary amine or phosphine; more preferably a weak base nucleophile anion chosen from the group carboxylate, halogenide or phenolate anions or 1,4-diazabicyclo-[2.2.2]-octane (DABCO) or an N-alkylimidazole, most preferably a carboxylate.

In another embodiment the separated catalyst system comprises a catalyst precursor composition P whereby the catalyst precursor P1 is a Michael addition donor and a catalyst activator composition C whereby the activator C1 is a Michael acceptor comprising an activated unsaturated group C═C reactive with P1. In such embodiment, in case C1 is an acrylate, P1 has a pKa of the conjugated acid below 8, preferably below 7 and more preferably below 6, wherein pKa is defined as the value in an aqueous environment, and in case C1 is a methacrylate, fumarate, itaconate or maleate, P1 has a pKa of the conjugated acid below 10.5, preferably below 9, more preferably below 8. The Michael acceptor activator C1 can be of the same type as defined as component B, or of a different (more reactive) nature.

Within this embodiment, the catalyst precursor composition (P) comprises a catalyst precursor P1 that is a weak base preferably selected from the group of phosphines, N-alkylimidazoles and fluorides or is a weak base nucleophile anion X⁻ from an acidic X—H group containing compound wherein X is N, P, O, S or C, wherein anion X⁻ is a Michael Addition donor reactive with activator C1.

A most preferred catalyst activator C1 contains an epoxy group. Suitable choices for the epoxide as preferred activator C1 are cycloaliphatic epoxides, epoxidized oils and glycidyl type epoxides. Suitable components C1 are described e.g. in U.S. Pat. No. 4,749,728 Col 3 Line 21 to 56 and include C10-18 alkylene oxides and oligomers and/or polymers having epoxide functionality including multiple epoxy functionality. Particularly suitable mono-epoxides include, tert-butyl glycidyl ether, phenyl glycidyl ether, glycidyl acetate, glycidyl esters of versatic esters, glycidyl methacrylate (GMA) and glycidyl benzoate. Useful multifunctional epoxides include bisphenol A diglycidyl ether, as well as higher homologues of such BPA epoxy resins, glycidyl ethers of hydrogenated BPA, such as Eponex 1510 (Hexion), ST-4000D (Kukdo), aliphatic oxirane such as epoxidised soybean oil, diglycidyl adipate, 1,4-diglycidyl butyl ether, glycidyl ethers of Novolac resins, glycidyl esters of diacids such as Araldite PT910 and PT912 (Huntsman), TGIC and other commercial epoxy resins. Bisphenol A diglycidyl ether, as well as its solid higher molecular weight homologues are preferred epoxides. Also useful are acrylic (co)polymers having epoxide functionality derived from glycidyl methacrylate. In a preferred embodiment, the epoxy components are oligomeric or polymeric components with an Mn of at least 400 (750, 1000, 1500). Other epoxide compounds include 2-methyl-1,2-hexene oxide, 2-phenyl-1,2-propene oxide (alpha-methyl styrene oxide), 2-phenoxy methyl-1,2-propene oxide, epoxidized unsaturated oils or fatty esters, and 1-phenyl propene oxide. Useful and preferred epoxides are glycidyl esters of a carboxylic acid, which can be on a carboxylic acid functional polymer or preferably on a highly branched hydrophobic carboxylic acid like Cardura E10P (glycidyl ester of Versatic™ Acid 10). Most preferred are typical powder crosslinker epoxy components: triglycidyl isocyanurate (TGIC), Araldite PT910 and PT912, and phenolic glycidyl ethers that are solid in nature at ambient temperature, or acrylic (co)polymers of glycidyl methacrylate.

Suitable examples of catalyst precursors P1 are weak base nucleophile anions chosen from the group carboxylate, phosphonate, sulphonate, halogenide or phenolate anions or salts thereof or a non-ionic nucleophile, preferably a tertiary amine or phosphine. More preferably, the weak base P1 is a weak base nucleophile anion chosen from the group carboxylate, halogenide or phenolate salt, most preferably carboxylate salts, or it is 1,4-diazabicyclo[2.2.2]octane (DABCO), or N-alkylimidazole. Catalyst precursor P1 is able to react with catalyst activator C1, which is preferably an epoxy, to yield a strongly basic anionic adduct which is able to start the reaction of the crosslinkable components A and B.

Another suitable example of a catalyst precursor P1 is a weak base nucleophile anion selected from the group of weak base anion X− from an acidic X—H group containing compound wherein X is N, P, O, S or C, wherein anion X− is a Michael Addition donor reactable with a Michael acceptor activator C1 and anion X− is characterized by a pKa of the corresponding conjugate acid X—H below 8, preferably below 7 and more preferably below 6, wherein pKa is defined as the value in an aqueous environment, and in case C1 is a methacrylate, fumarate, itaconate or maleate, P1 has a pKa of the conjugated acid below 10.5, preferably below 9, more preferably below 8.

The catalyst precursor which is a weak base P1 preferably reacts with catalyst activator C1 at temperatures below 150° C., preferably 140, 130, 120 and preferably at least 70, preferably at least 80 or 90° C. on the time scale of the cure process. The reaction rate of weak base P1 with activator C1 at the cure temperature is sufficiently low to provide a useful open time, and sufficiently high to allow sufficient cure in the intended time window.

When the catalyst precursor P1 is an anion, it is preferably added as a salt comprising a cation that is not acidic. Not acidic means not having a hydrogen that competes for base with crosslinkable donor component A, and thus not inhibiting the crosslinking reaction at the intended cure temperature. Preferably, the cation is substantially non-reactive towards any components in the crosslinkable composition. The cations can e.g. be alkali metals, quaternary ammonium or phosphonium but also protonated ‘superbases’ that are non-reactive towards any of the components A, B or C in the crosslinkable composition. Suitable superbases are known in the art.

Preferably, the salt comprises alkali- or earth-alkali metal, in particular lithium, sodium or potassium cation or, more preferably, a quaternary ammonium or phosphonium cation according to formula Y(R′)4, wherein Y represents N or P, and wherein each R′ can be a same or different alkyl, aryl or aralkyl group possibly linked to a polymer or wherein the cation is a protonated very strong basic amine, which very strong basic amine is preferably selected from the group of amidines; preferably 1,8-diazabicyclo (5.4.0)undec-7-ene (DBU), or guanidines; preferably 1,1,3,3-tetramethylguanidine (TMG). R′ can be substituted with substituents that do not or not substantially interfere with the RMA crosslinking chemistry as is known to the skilled person. Most preferably R′ is an alkyl having 1 to 12, most preferably 1 to 4 carbon atoms.

Optionally, in some preferred embodiments, the separated catalyst system further comprises a retarder T, which is an acid that has a pKa of 2, preferably 3, more preferably 4 and most preferably 5 points lower than that of the activated C—H in the crosslinkable donor component A, and which upon deprotonation produces a weak base that can act as a P1 precursor, and can react with the activator C1, to produce a strong base that can catalyze the Michael Addition reaction between A and B. The retarder T is preferably a protonated precursor P1. The retarder T can be part of the catalyst precursor composition or of the catalyst activator composition. It can also be part of both the catalyst precursor composition and the catalyst activator composition. Preferably the retarder T and the protonated precursor P1 have a boiling point of at least 120° C., preferably 130° C., 150, 175, 200 or even 250° C. Preferably, retarder T is a carboxylic acid. The use of a retarder T can have beneficial effects in postponing the crosslinking reaction to allow more interdiffusion of the components during cure, before mobility limitations become significant.

In one specific embodiment, the catalyst activator C1 is an acrylate acceptor group and component P1 and T are X⁻/X—H components, preferably carboxylate/carboxylic acid compounds, having (in acid form) pKa below 8, more preferably below 7, 6 or even 5.5. Examples of useful X—H components for acrylate acceptor containing powder paint compositions include cyclic 1,3-diones as 1,3-cyclohexanedione (pKa 5.26) and dimedone (5,5-dimethyl-1,3-cyclohexanedione, pKa 5.15), ethyl trifluoroacetoacetate (7.6), Meldrum's acid (4.97). Preferably, X—H components are used that have a boiling point of at least 175° C., more preferably at least 200° C.

In another embodiment, the catalyst activator C1 is a methacrylate, fumarate, maleate or itaconate acceptor group, preferably methacrylate, itaconate or fumarate groups, and components P1 and T are X⁻/X—H components having acid pKa below 10.5, more preferably below 9.5, 8 or even below 7.

The pKa values referred to in this patent application, are aqueous pKa values at ambient conditions) (21° C. They can be readily found in literature and if needed, determined in aqueous solution by procedures known to those skilled in the art.

To be able to provide a helpful delay of the crosslinking reaction under cure conditions, the reaction of the retarder T and its deprotonated version P1 with activator C1 should take place with a suitable rate. A preferred separated catalyst system comprises as catalyst activator C1 an epoxy, as catalyst precursor P1 a weak base nucleophilic anion group that reacts with the epoxide group of C1 to form a strongly basic adduct C1, and most preferably also a retarder T. In a suitable separated catalyst system, P1 is a carboxylate salt and C1 is epoxide, carbodiimide, oxetane or oxazoline, more preferably an epoxide or carbodiimide, and T is a carboxylic acid. Alternatively P1 is DABCO, C1 is an epoxy, and T is a carboxylic acid.

Without wishing to be bound to a theory it is believed that the nucleophilic anion P1 reacts with the activator epoxide C1 to give a strong base, but that this strong base is immediately protonated by the retarder T to create a salt (similar in function to P1) that will not directly strongly catalyse the crosslinking reaction. The reaction scheme takes place until substantially complete depletion of the retarder T, which provides for the open time because no significant amount of strong base is present during that time to significantly catalyse the reaction of the crosslinkable components A and B. When the retarder T is depleted, a strong base will be formed and survive to effectively catalyse the rapid RMA crosslinking reaction.

The features and advantages of the invention will be appreciated upon reference to the following exemplary reaction scheme.

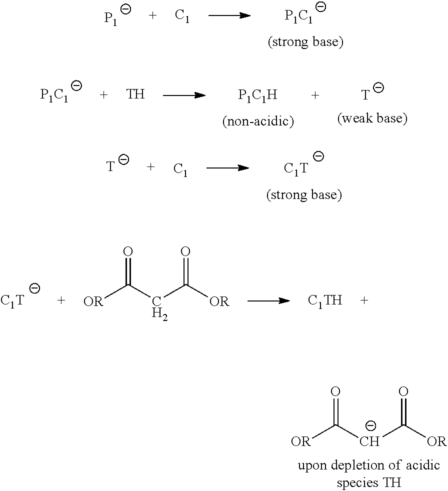

Specifically for the case of carboxylates, epoxides and carboxylic acids as P1, C1 and T species, this can be drawn up as: **replaced the picture**

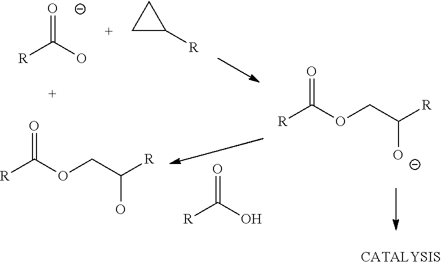

In some cases, the detailed mechanism of the reaction of the activator C1 with the precursor P1 may not be known, or subject of debate, and a reaction mechanism involving the protonated form of P1 actually involved in the reaction may be suggested. The net effect of such a reaction sequence might be similar to the sequence described based on its progress though the deprotonated form of P1. Systems where reaction might be argued to proceed along the protonated P1 pathway, are included in this invention. In this case, after depletion of the retarder T, C1 would react with a protonated P1 created from the acid-base equilibrium with Michael donor species A, and its reaction would activate crosslinking due to this acid-base equilibrium being drawn to the deprotonated Michael donor side.

The reaction scheme, if the activator would react through the protonated form of P1H would be illustrated by the next scheme:

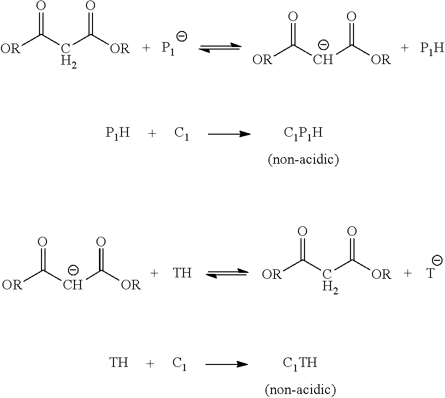

In one embodiment retarder T is a protonated anion group P1, preferably carboxylic acid T and carboxylate P1, which for example can be formed by partially neutralising an acid functional component, preferably a polymer comprising acid groups as retarder T to partially convert to anionic groups on P1, wherein the partial neutralizing is done preferably by a cation hydroxide or (bi)carbonate, preferably tetraalkylammonium or tetraalkylphosphonium cations. In another embodiment, a polymer bound component P1 can be made by hydrolysis of an ester group in a polyester with aforementioned hydroxides.

It is preferred that the boiling point of the component T and of the conjugate acid of P1 are above the envisaged curing temperature of the powder coating composition blend to prevent less well controlled evaporation of these catalyst system components during curing conditions. Formic acid and acetic acid are less preferred retarders T as they may evaporate during curing. Preferably, retarder T and the conjugate acid of P1 have a boiling point higher than 120° C.

Although less preferred, it is possible that at least one of the components P1, C1, or T of the separated catalyst system is a group on one of the crosslinkable components A or B or both. In that case it must be ensured that P1 and C1 are macrophysically separated in the powder coating composition blend. It is possible that one or more but not all groups of P1, C1 and T are on RMA crosslinkable components A or B or both. In a convenient embodiment both P1 and T are on the RMA crosslinkable component A and/or B and P1 is preferably formed by partially neutralising an acid functional polymer comprising acid groups of T with a base comprising a cation as described above to partially convert acid groups on T to anionic groups on P1. Another embodiment would have component P1 formed by hydrolysis of a polyester, e.g. of a polyester of component A, and be present as a polymeric species.

The powder coating composition blend preferably comprises in case of a separated catalyst system
a. an activator C1 in an amount between 1 and 600 μeq/gr, preferably between 10 and 400, more preferably between 20 and 200 μeq/gr, wherein μeq/gr is μeq relative to total weight of binder components A and B and the separated catalyst system,
b. a precursor that is a weak base P1 in an amount between 1 and 300 μeq/gr, preferably between 10 and 200, more preferably between 20 and 100 μeq/gr relative to total weight of binder components A and B and separated catalyst system,
c. optionally a retarder T in an amount between 1 and 500, preferably between 10 and 400, more preferably between 20 and 300 μeq/gr and most preferably between 30 and 200 μeq/gr,
d. wherein preferably the equivalent amount of C1
i. is higher than the equivalent amount of T, preferably by an amount between 1 and 300 μeq/gr, preferably between 10 and 200, more preferably between 20 and 100 μeq/gr and
ii. is preferably higher than the equivalent amount of P1 and
iii. is preferably higher than the sum of the equivalent amount of P1 and T.

However, in case whereby the activator C1 is a Michael acceptor comprising an activated unsaturated group C═C reactive with P1, there is no relevant upper limit in concentration as in this case C1 may be also component B.

It is also possible that the separated catalyst system works with the amount of C1 being lower than of P1. However, this is less preferred as it will leave unreacted P1. In case the amount of C1, in particular epoxide, is higher than the amount of P1 the drawbacks are limited as it may react with P1 and T or other nucleophilic remains, but still maintain basicity after reaction or it may be left in the network, without too much problems. Nevertheless, excess of C1 may be disadvantageous in view of cost for C1 other than epoxy.

Further, it is preferred that in the powder coating composition blend
a. the precursor P1 represents between 10 and 100 equivalent % of the sum of P1 and T,
b. preferably the amount of retarder T is 20-400 eq %, preferably 30-300 eq % of the amount of P1,
c. wherein preferably the ratio of the equivalent of C1 to the sum of the equivalent of P1 and T is at least 0.5, preferably at least 0.8, more preferably at least 1 and preferably at most 3, more preferably at most 2,
d. the ratio of the equivalent of C1 to T is preferably at least 1, preferably at least 1.5, most preferably at least 2.

In one embodiment the RMA crosslinkable composition comprises a polymer and its use as a latent base catalyst component in RMA crosslinkable coating compositions, said polymer comprising a catalyst precursor groups P1 and optionally acid groups T, wherein P1 groups are preferably formed by partially or fully neutralizing acid groups T on the polymer, wherein P1 and T are preferably carboxylate and carboxylic acid groups, wherein the polymer is preferably chosen from the group of acrylic, polyester, polyester-amide and polyester-urethane polymers, wherein the polymer optionally comprises C—H donor groups, C═C acceptor groups or both, wherein the polymer preferably has
a) an acid value in non-neutralized form of at least 3, more preferably 5, 7, 10, 15 or even 20 mg KOH/g, and preferably less than 100, 80, 70, 60 mg KOH/g,
b) a quaternary ammonium or phosphonium cation, preferably a tetrabutyl- or ethylammonium cation
c) an Mn at least 500, preferably at least 1000 or even 2000, and Mw no more than 20,000, preferably no more than 10,000 or 6000,
d) in case C—H donor and/or C═C acceptor groups are present; a reactive C—H donor or C═C acceptor equivalent weight of at least 150, preferably at least 250, 350 or even 450 g/mol and no more than 2000, preferably no more than 1500, 1200 or 1000 g/mol.

### A Powder Coating Composition Blend Based on Separated Crosslinkable Components

In one embodiment of the invention the crosslinkable components A and B are macrophysically separated. In that case, the catalyst system is a latent catalyst system LCS comprising the catalyst precursor P1 and the catalyst activator C1 or a non-latent catalyst system comprising a strong base (i.e. already capable of activating the RMA crosslinking reaction). The RMA reaction will only take place at curing temperature when component A and B become chemically accessible with each other and the catalyst system catalyses the RMA reaction.

The latent catalyst system comprises components C1, P1 and optionally T as described above.

A non-latent catalyst system comprises as strong base having a basicity that is high enough to be able to deprotonate the Michael donor groups to initiate the RMA crosslinking with donor and acceptor present. Strong bases can compose of many active catalysts described in literature, typically strong bases are salts of basic anions (e.g. hydroxide, carbonates) and non-acidic cations (alkali or earth alkali metals, quaternary ammonium or phosphonium ions), strongly basic amines such as amidines and guanidines e.g. DBU, DBN, TBD or TMG, and other strong bases known to those skilled in the art.

### Crosslinkable Components A and B

The powder coating composition blend further comprises the crosslinkable composition comprising
a) the crosslinkable donor component A having at least 2 acidic C—H donor groups in activated methylene or methine, and
b) the crosslinkable acceptor component B having at least 2 activated unsaturated acceptor groups C═C, which react with component A by Real Michael Addition (RMA) to form a crosslinked network,

Preferably, the crosslinkable component A comprises at least 2 acidic C—H donor groups in activated methylene or methine in a structure Z1(—C(—H)(—R)—)Z2 wherein R is hydrogen, a hydrocarbon, an oligomer or a polymer, and wherein Z1 and Z2 are the same or different electron-withdrawing groups, preferably chosen from keto, ester or cyano or aryl groups, and preferably comprises an activated C—H derivative having a structure according to formula 1:

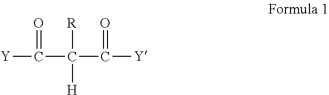

wherein R is hydrogen or an optionally substituted alkyl or aryl and Y and Y′ are identical or different substituent groups, preferably alkyl, aralkyl or aryl, or alkoxy or wherein in formula 1 the —C(═O)—Y and/or —C(═O)—Y′ is replaced by CN or aryl, no more than one aryl or wherein Y or Y′ can be NRR′ (R and R′ are H or optionally substituted alkyl) but preferably not both, wherein R, Y or Y′ optionally provide connection to an oligomer or polymer, said component A preferably being malonate, acetoacetate, malonamide, acetoacetamide or cyanoacetate groups, preferably providing at least 50, preferably 60, 70 or even 80% of the total of C—H acidic groups in crosslinkable component A.

Component B comprises at least 2 activated unsaturated RMA acceptor groups that preferably originate from acryloyl, methacryloyl, itaconates, maleate or fumarate functional groups,

Preferably at least one, more preferably both, of components A or B is a polymer

Preferably, the crosslinkable composition comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

Real Michael Addition (RMA) crosslinkable coating compositions comprising crosslinkable components A and B are generally described for use in solvent borne systems in EP2556108, EP0808860 or EP1593727 which specific description for crosslinkable components A and B are herewith considered to be enclosed.

The components A and B respectively comprise the RMA reactive donor and acceptor moieties which on curing react to form the crosslinked network in the coating. The components A and B can be present on separate molecules but can also be present on one molecule, referred to as a hybrid A/B component, or combinations thereof. In case the crosslinkable components A and B are macrophysically separated, they cannot be hybrid A/B components.

Preferably, components A and B are separate molecules and each independently in the form of polymers, oligomers, dimers or monomers. For coating applications, it is preferred at least one of component A or B preferably are oligomers or polymers. It is noted that an activated methylene group CH2 comprises 2 C—H acidic groups. Even though, after reaction of the first C—H acidic group, the reaction of the second C—H acid group is more difficult, e.g. for reaction with methacrylates, as compared to acrylates, the functionality of such activated methylene group is counted as 2. The reactive components A and B can also be combined in one A/B hybrid molecule. In this embodiment of the powder coating composition blend both C—H and C═C reactive groups are present in one A-B molecule.

Preferably, component A is a polymer, preferably a polyester, polyurethane, acrylic, epoxy or polycarbonate, having as a functional group a component A and optionally one or more components B, or components from catalytic system C. Also, mixtures or hybrids of these polymer types are possible. Suitably component A is a polymer chosen from the group of acrylic, polyester, polyester amide, polyester-urethane polymers.

Malonates or acetoacetates are preferred donor types in component A. In view of high reactivity and durability in a most preferred embodiment of the crosslinkable composition, component A is a malonate C—H containing compound. It is preferred that in the powder coating composition blend the majority of the activated C—H groups are from malonate, that is more than 50%, preferably more than 60%, more preferably more than 70%, most preferably more than 80% of all activated C—H groups in the powder coating composition blend are from malonate.

Preferred are oligomeric and/or polymeric malonate group-containing components such as, for example, polyesters, polyurethanes, polyacrylates, epoxy resins, polyamides and polyvinyl resins or hybrids thereof containing malonate type groups in the main chain, pendant or both.

The total amount of donor groups C—H and acceptor groups C═C per gram binder solids, independent of how they are distributed over the various crosslinkable components, is preferably between 0.05 to 6 meq/gr, more typically 0.10 to 4 meq/gr, even more preferably 0.25 to 3 meq/gr binder solids, most preferably between 0.5 to 2 meq/gr. Preferably, the stoichiometry between components A and B is chosen such that the ratio of reactive C═C groups to reactive C—H groups is more than 0.1, preferably more than 0.2, more preferably more than 0.3, most preferably more than 0.4, and, in the case of acrylate functional groups B preferably more than 0.5 and most preferably more than 0.75, and the ratio is preferably less than 10, preferably 5, more preferably less than 3, 2 or 1.5.

The malonate group-containing polyesters can be obtained preferably by the transesterification of a methyl or ethyl diester of malonic acid, with multifunctional alcohols that can be of a polymeric or oligomeric nature but can also be incorporated through a Michael Addition reaction with other components. Especially preferred malonate group-containing components for use with the present invention are the malonate group-containing oligomeric or polymeric esters, ethers, urethanes and epoxy esters and hybrids thereof, for example polyester-urethanes, containing 1-50, more preferably 2-10, malonate groups per molecule. Polymer components A can also be made in known manners, for example by radical polymerisation of ethylenically unsaturated monomers comprising monomers, for example (meth)acrylate, functionalised with a moiety comprising activated C—H acid (donor) groups, preferably an acetoacetate or malonate group, in particular 2-(methacryloyloxy)ethyl acetoacetate or—malonate. In practice polyesters, polyamides and polyurethanes (and hybrids of these) are preferred. It is also preferred that such malonate group containing components have a number average molecular weight (Mn) in the range of from about 100 to about 10000, preferably 500-5000, most preferably 1000-4000; and a Mw less than 20000, preferably less than 10000, most preferably less than 6000 (expressed in GPC polystyrene equivalents).

Suitable crosslinkable components B generally can be ethylenically unsaturated components in which the carbon-carbon double bond is activated by an electron-withdrawing group, e.g. a carbonyl group in the alpha-position. Representative examples of such components are disclosed in U.S. Pat. No. 2,759,913 (column 6, line 35 through column 7, line 45), DE-PS-835809 (column 3, lines 16-41), U.S. Pat. No. 4,871,822 (column 2, line 14 through column 4, line 14), U.S. Pat. No. 4,602,061 (column 3, line 14 20 through column 4, line 14), U.S. Pat. No. 4,408,018 (column 2, lines 19-68) and U.S. Pat. No. 4,217,396 (column 1, line 60 through column 2, line 64).

Acrylates, methacrylates, itaconates, fumarates and maleates are preferred. Itaconates, fumarates and maleates can be incorporated in the backbone of a polyester or polyester-urethane. Preferred example resins such as polyesters, polycarbonates, polyurethanes, polyamides, acrylics and epoxy resins (or hybrids thereof) polyethers and/or alkyd resins containing activated unsaturated groups may be mentioned. These include, for example, urethane (meth)acrylates obtained by reaction of a polyisocyanate with an hydroxyl group containing (meth)acrylic ester, e.g., an hydroxy-alkyl ester of (meth)acrylic acid or a component prepared by esterification of a poly-hydroxyl component with less than a stoichiometric amount of (meth)acrylic acid; polyether (meth)acrylates obtained by esterification of an hydroxyl group-containing polyether with (meth)acrylic acid; poly-functional (meth)acrylates obtained by reaction of an hydroxy-alkyl (meth)acrylate with a poly-carboxylic acid and/or a poly-amino resin; poly(meth)acrylates obtained by reaction of (meth)acrylic acid with an epoxy resin, and poly-alkyl maleates obtained by reaction of a mono-alkyl maleate ester with an epoxy resin and/or an hydroxy functional oligomer or polymer. Also, polyesters end-capped with glycidyl methacrylate are a preferred example. It is possible that the acceptor component contains multiple types of acceptor functional groups.

Most preferred activated unsaturated group-containing components B are the unsaturated acryloyl, methacryloyl and fumarate functional components. Preferably the number average functionality of activated C═C groups per molecule is 2-20, more preferably 2-10, most preferably 3-6. The equivalent weight (EQW: average molecular weight per reactive functional group) is 100-5000, more preferable 200-2000, and the number average molecular weight preferably is Mn 200-10000, more preferable 300-5000, most preferably 400-3500 g/mole, even more preferably 1000-3000 g/mole.

In view of the use in powder systems the Tg of component B is preferably above 25, 30, 35, more preferably at least 40, 45, most preferably at least 50° C. or even at least 60° C., because of the need for powder stability. The Tg is defined as measured with DSC, mid-point, heating rate 10° C./min. If one of the components has a Tg substantially higher than 50° C., the Tg of the other formulation components can be lower as will be understood by those skilled in the art.

A suitable component B is a urethane (meth)acrylate which has been prepared by reacting a hydroxy- and (meth)acrylate functional compound with isocyanate to form urethane bonds, wherein the isocyanates are preferably at least in part di- or tri-isocyanates, preferably isophorone diisocyanate (IPDI). The urethane bonds introduce stiffness on their own but preferably high Tg isocyanates are used like cyclo-aliphatic or aromatic isocyanates, preferably cycloaliphatic. The amount of such isocyanates used is preferably chosen such that said (meth)acrylate functional polymer Tg is raised above 40, preferably above 45 or 50° C.

The powder coating composition blend is designed preferably in such a way, that after cure, a crosslink density (using DMTA) can be determined of at least 0.025 mmole/cc, more preferably at least 0.05 mmole/cc, most preferably at least 0.08 mmole/cc. and typically less than 3, 2, 1 or 0.7 mmole/cc.

The powder coating composition blend should retain free flowing powder at ambient conditions and therefore preferably has a Tg above 25° C., preferably above 30° C., more preferably above 35, 40, 50° C. as the midpoint value determined by DSC at a heating rate of 10° C./min.

As described above the preferred component A is a malonate functional component. However, incorporation of malonate moieties tends to reduce the Tg and it has been a challenge to provide powder coating composition blends based on malonate as the dominant component A with sufficiently high Tg.

In view of achieving high Tg, the powder coating composition blend preferably comprises a crosslinkable composition of which crosslinkable donor component A and/or the crosslinkable acceptor component B, which may be in the form of a hybrid component A/B, comprises amide, urea or urethane bonds and/or whereby the crosslinkable composition comprises high Tg monomers, preferably cycloaliphatic or aromatic monomers or in case of polyesters, one or more monomers chosen from the group of 1,4-dimethylol cyclohexane (CHDM), tricyclodecanedimethanol (TCD diol), isosorbide, penta-spiroglycol, hydrogenated bisphenol A and tetra-methyl-cyclobutanediol.

Further, in view of achieving high Tg, the powder coating composition blend comprises component B or hybrid component A/B being a polyester (meth-)acrylate, a polyester urethane (meth-)acrylate, an epoxy (meth-)acrylate or a urethane (meth-)acrylate, or is a polyester comprising fumarate, maleate or itaconate units, preferably fumarate or is a polyester end-capped with isocyanate or epoxy functional activated unsaturated group.

Most preferably the powder coating composition blend comprises an RMA crosslinkable composition, which has features adapted for use in an RMA crosslinkable powder coating composition blend. In particular in view of achieving good flow and levelling properties, and good chemical and mechanical resistances, it was found that preferably in the powder coating composition blend at least one of crosslinkable components A or B or hybrid A/B is a polymer, preferably chosen from the group of acrylic, polyester, polyester amide, polyester-urethane polymers, which polymer
a) has a number average molecular weight Mn, as determined with GPC, of at least 450 gr/mole, preferably at least 1000, more preferably at least 1500 and most preferably at least 2000 gr/mole,
b) has a weight average molecular weight Mw, as determined with GPC, of at most 20000 gr/mole, preferably at most 15000, more preferably at most 10000 and most preferably at most 7500 gr/mole,
c) preferably has a polydispersity Mw/Mn below 4, more preferably below 3, and evidently above 1
d) has an equivalent weight EQW in C—H or C═C of at least 150, 250, 350, 450 or 550 gr/mole and preferably at most 2500, 2000, 1500, 1250 or 1000 gr/mole and a number average functionality of reactive groups C—H or C═C between 1-25, more preferably 1.5-15 even more preferably 2-15, most preferably 2.5-10 C—H groups per molecule,
e) preferably has a melt viscosity at a temperature in the range between 100 and 140° C. less than 60 Pas, more preferably less than 40, 30, 20, 10 or even 5 Pas
f) preferably comprises amide, urea or urethane bonds and/or comprises high Tg monomers, preferably cycloaliphatic or aromatic monomers, in particular polyester monomers chosen from the group of 1,4-dimethylol cyclohexane (CHDM), tricyclodecanedimethanol (TCD diol), isosorbide, penta-spiroglycol or hydrogenated bisphenol A and tetramethyl-cyclobutanediol,
g) has a Tg above 25° C., preferably above 35° C., more preferably above 40, 50 or even 60° C. as as the midpoint value determined by DSC at a heating rate of 10° C./min or is a crystalline polymer with a melting temperature between 40° C. and 150, preferably 130° C., preferably at least 50 or even 70° C. and preferably lower than 150, 130 or even 120° C. (as determined by DSC at a heating rate of 10° C./min).

The polymer features Mn, Mw and Mw/Mn are chosen in view of on one hand the desired powder stability and on the other hand the desired low melt viscosity, but also the envisaged coating properties. A high Mn is preferred to minimize Tg reduction effects of end groups, on the other hand low Mw's are preferred because melt viscosity is very much related to Mw and a low viscosity is desired; therefore low Mw/Mn is preferred.

In view of achieving high Tg the RMA crosslinkable polymer preferably comprises amide, urea or urethane bonds and/or comprising high Tg monomers, preferably cycloaliphatic or aromatic monomers, or in case of polyesters comprises monomers chosen from the group of 1,4-dimethylol cyclohexane (CHDM), TCD diol, isosorbide, penta-spiroglycol or hydrogenated bisphenol A and tetramethyl-cyclobutanediol.

In case the RMA crosslinkable polymer is an A/B hybrid polymer it is further preferred that the polymer also comprises one or more component B groups chosen from the group of acrylate or methacrylate, fumarate, maleate and itaconate, preferably (meth)acrylate or fumarate. Further, if to be used as crystalline material, it is preferred that the RMA crosslinkable polymer has crystallinity with a melting temperature between 40° C. and 130° C., preferably at least 50 or even 70° C. and preferably lower than 150, 130 or even 120° C. (as determined by DSC at a heating rate of 10° C./min) It is noted that this is the melting temperature of the (pure) polymer itself and not of the polymer in a blend

In a preferred embodiment the RMA crosslinkable polymer comprising polyester, polyester amide, polyester-urethane or a urethane-acrylate which comprises urea, urethane or amide bonds derived from cycloaliphatic or aromatic isocyanates, preferably cycloaliphatic isocyanates, said polymer having a Tg of at least 40° C., preferably at least 45 or 50° C. and at most 120° C. and a number average molecular weight Mn of 450-10000, preferably 1000-3500 gr/mole and preferably a maximum Mw of 20000, 10000 or 6000 gr/mole and which polymer is provided with RMA crosslinkable components A or B or both. The polymer is obtainable for example by reacting a precursor polymer comprising said RMA crosslinkable groups with an amount of cycloaliphatic or aromatic isocyanates to increase the Tg. The amount of such isocyanates added, or urea/urethane bonds formed, is chosen such the Tg is raised to at least 40° C., preferably at least 45 or 50° C.

Preferably, the RMA crosslinkable polymer is a polyester or polyester-urethane comprising a malonate as the dominant component A and comprising a number average malonate functionality of between 1-25, more preferably 1.5-15 even more preferably 2-15, most preferably 2.5-10 malonate groups per molecule, has a GPC weight average molecular weight between 500 and 20000, preferably 1000-10000, most preferably 2000-6000 gr/mole, which has been prepared by reacting a hydroxy- and malonate functional polymer with isocyanate to form urethane bonds.

Further, the polymer can be an amorphous or (semi-)crystalline polymer or a mixture thereof. Semi-crystalline means being partly crystalline and partly amorphous. (Semi)-crystallinity is to be defined by DSC melting endotherms, targeted crystallinity defined as having a DSC peak melting temperature Tm at least 40° C., preferably at least 50° C., more preferably at least 60° C. and preferably at most 130, 120, 110 or 100° C. The DSC Tg of such a component in fully amorphous state preferably is below 40° C., more preferably below 30, 20 or even 10° C.

### Substrate and Coating

The invention also relates to a method for powder-coating a substrate comprising
a. Providing the powder coating composition blend according to the invention,
b. Applying a layer of the powder to a substrate surface and
c. Heating to a curing temperature Tour between 75 and 200° C., preferably between 80 and 180° C. and more preferably between 80 and 160, 150, 140, 130 or even 120° C., optionally and preferably using infrared heating,
d. and curing at Tour for a curing time preferably less than 40, 30, 20, 15, 10 or even 5 minutes.

In the method the curing at Tour is preferably characterised by a curing profile, as determined by measuring the conversion of the unsaturated bonds C═C of component B as a function of time by FTIR wherein the ratio of the time to go from 20% to 60% C═C conversion to the time to reach 20% conversion is less than 1, preferably less than 0.8, 0.6, 0.4 or 0.3, preferably with the time to reach 60% conversion being less than 30 or 20 or 10 min and the powder coating composition at the Tour preferably has a melt viscosity at the curing temperature less than 60 Pas, more preferably less than 40, 30, 20, 10 or even 5 Pas. The melt viscosity is to be measured at the very onset of the reaction or without C2 of the catalysis system.

In a preferred embodiment of the method the curing temperature is between 75 and 140° C., preferably between 80 and 120° C. and the catalyst system C is a latent catalyst system as described above which allows for powder coating a temperature sensitive substrate, preferably MDF, wood, plastic or temperature sensitive metal substrates like alloys.

Therefore, the invention also relates to articles coated with a powder coating composition of the invention, preferably having a temperature sensitive substrate like MDF, wood, plastic or metal alloys and wherein preferably the crosslinking density XLD of the coating is at least 0.01, preferably at least 0.02, 0.04, 0.07 or even 0.1 mmole/cc (as determined by DMTA) and is preferably lower than 3, 2, 1.5, 1 or even 0.7 mmole/cc.

The invention will be illustrated by the following examples.

### Test Methods

### Acid Value

A freshly prepared solvent blend of 1:1 xylene: ethanol is prepared. A quantity of resin is accurately weighed out into a 250 ml conical flask. 50-60 ml of 1:1 xylene: ethanol is then added. The solution is heated gently until the resin is entirely dissolved, and ensuring the solution does not boil. The solution is then cooled to room temperature and a potentiometric titration was conducted with 0.1 M potassium hydroxide until after the equivalence point.

### OH Value

OH value (OHV) is defined as the number of mg KOH equivalent to the amount of acetic acid esterified after the acetylation reaction of the hydroxyl group of a 1 g sample. The OHV was determined by manual titration of the prepared blanks and sample flasks. The acetylating solution is prepared by weighing 15 g (accuracy 0.001) of acetic anhydride diluted with Analytical grade pyridine in a 250 ml Erlenmeyer flask. In a flask with a sample accurately weighted, 20 ml of acetylating mixture are added. The acetylated solution with the sample is put in a thermostatic bath at 100° C. and left in reflux for 1 hour. After cooling and addition of water for hydrolyzing the unreacted acetic anhydride the solution with the sample is ready for titration. A blank solution is prepared with the same procedure except that no sample is added. The indicator solution is made up by dissolving 0.80 g of Thymol Blue and 0.25 g of Cresol Red in 1 L of methanol. 10 drops of indicator solution is added to the flask which is then titrated with the standardized 0.5N methanolic potassium hydroxide solution. The end point is reached when the color changes from yellow to grey to blue and gives a blue coloration which is maintained for 10 seconds. The hydroxyl value is then calculated according to:

$$Hydroxyl Value = ( B - S ) \times N \times 56. 1 / M + A V$$

Where:

B=ml of KOH used for blank titration

S=ml of KOH used for sample titration

N=normality of potassium hydroxide solution

M=sample weight (base resin)

AV=Acid Value of the base resin

The Net Hydroxyl Value is defined as: Net OHV=(B−S)×N×56.1/M

### Amine Value

A freshly prepared solvent blend of 3:1 xylene: ethanol propanol is prepared. A quantity of resin is accurately weighed out into a 250 ml conical flask. 50-60 ml of 3:1 xylene: ethanol is then added. The solution is heated gently until the resin is entirely dissolved, and ensuring the solution does not boil. The solution is then cooled to room temperature and a potentiometric titration was conducted with 0.1 M hydrochloride acid until after the equivalence point.

### GPC Molecular Weight

Molar mass distribution of polymers was determined with Gel Permeation Chromatography (GPC) on Perkin-Elmer HPLC series 200 equipment, using refractive index (RI) detector and PLgel column, using as eluents THF, using calibration by polystyrene standards. Experimental molecular weights are expressed as polystyrene equivalents.

### DSC Tg

Resin and paint glass transition temperatures reported herein are the mid-point Tg's determined from Differential Scanning calorimetry (DSC) using a heating rate of 10° C./min.

### Film Thickness (DFT)

Film thicknesses (DFT) were measured using Positector 6000 Coating Thickness Gauges.

Gloss at)(60°

The gloss of the coatings is measured using Zehntner ZGM 1130 gloss meter.

### Solvent Resistance

The solvent resistance of the cured film is measured by double rubs using a small cotton ball saturated with methyl ethyl ketone (MEK). It is judged by either number of rubs to rub through (50 to pass) or using a rating system (0-5, best to worst) as described below.
0. no perceptible change. Cannot be scratched with a finger-nail
1. slight loss of gloss
2. Some loss of gloss
3. the coating is very dull and can be scratched with a finger-nail
4. the coating is very dull and quite soft
5. the coating is cracked

### Chemical Storage Stability:

The chemical stability of the powder coating compositions can be determined by measuring the kinetic profile of a composition using Differential Scanning calorimetry (DSC). In this method, we measure the reaction exotherm of a powder coating composition at a relevant temperature as a function of time in an isothermal scan. The sample is heated to the cure temperature of interest at a rate of 60° C./min, and heat evolved is measured as function of time from this moment. An exotherm peak is observed, typically after a certain induction time. The onset time (in minutes) of such reaction exotherm is recorded as ts. We can determine the ts when the powder coating composition is freshly prepared (i.e. tsf), and after storage for a certain period at 35° C. (i.e. tss). Alternatively, for powder coating compositions that have very short or no induction time at the temperature of interest, we can measure the reaction exotherm in an temperature scan between 10-230° C. Using this method, the onset of the reaction exotherm is observed at a particular temperature and it can be replot to determine the onset time, as the heat rate is constant at 10° C./min. A storage stability factor (SSF) can be determined by the difference between tsf and tss, divided by storage time (t).

$$S S F ( D S C ) = ( tsf - t ss ) / t$$

This factor indicates the degree of pre-mature reactions in powder coating compositions during storage. Powder coating compositions have preferably an SSF value of close to zero min/day and preferably less than 0.1 min/day.

### Particle Size Measurement

The particle sizes are measured using Static light scattering (SLS) using Malvern Mastersizer 3000 fitted with a Aero S powder dispersion unit. For the feed and dispersion of the powder in the optical chamber the rate was set at 35% and a pressure not exceeding 2 bars. The volume particle size distribution was determined according to the Fraunhofer diffraction approach. Each value given is an average of 5 measurements of Dx(50).

### Abbreviations

TABLE 1
description of the abbreviations used in the examples.

| | |
|---|---|
| NPG | neopentyl glycol |
| IPA | isophthalic acid |
| TPA | terephthalic acid |
| IPDI | isophorone diisocyanate |
| TGIC | triglycidyl isocyanurate |
| TEAHCO₃ | tetraethylammonium bicarbonate |
| Methyl ethyl ketone | MEK |
| AV | acid value |
| OHV | hydroxyl value |
| Wt % | weight percent |
| Mn | number average molecular weight |
| Mw | weight average molecular weight |
| Tg | glass transition Temperature |
| EQW | equivalent weight |

| | | |
|---|---|---|
| Araldite ® PT912 | glycidyl ester resin (ex Huntsman) | |
| Araldite ® GT7004 | bisphenol-A epoxy resin (ex Huntsman) | epoxy EQW is 752 |
| Eponex ™ Resin 1510 | hydrogenated bisphenol-A resin (ex Hexion) | epoxy EQW is 210 |
| MODAFLOW ® P6000 | powder coating flow modifiers on silica carrier (ex | |
| | Allnex) | |
| Ken-React ® KR46B | titanium (IV) tetrakis octanolato adduct 2 moles | |
| | (di-tridecyl)hydrogen phosphite (Kenrich | |
| | petrochemicals, Inc) | |

### Preparation of Materials

### Preparation of Malonate Donor Resin

A 5 litre round bottom reactor equipped with a 4 necked lid, metal anchor stirrer, Pt-100, packed column with top thermometer, condenser, distilate collection vessel, thermocouple and a N2 inlet was charged with 1300 g isosorbide (80%), 950 g NPG and 1983 TPA. The temperature of the reactor was gently raised to about 100° C., and 4.5 g of Ken-React® KR46B catalyst was added. The reaction temperature was further increased gradually to 230° C., and the polymerization was progressed under nitrogen with continuous stirring until the reaction mixture is clear and the acid value is below 2 mg KOH/g. During the last part of the reaction, vacuum was applied to push the reaction to completion. The temperature was lowered to 120° C., and 660 g of diethylmalonate was added. The temperature of the reactor was then increased to 190° C. and maintained until no more ethanol was formed. Again, vacuum was applied to push the reaction to completion. After the transesterification was completed, the hydroxyl value of the polyester was measured. The final OHV was 27 mg KOH/g, with a GPC Mn of 1763 and a Mw of 5038, and a Tg (DSC) of 63° C.

### Preparation of Urethane Acrylate Acceptor Resin

A urethane-acrylate based on IPDI, hydroxy-propyl-acrylate, glycerol is prepared with the addition of suitable polymerization inhibitors, as described in e.g EP0585742. In a 5 litre reactor equipped with thermometer, stirrer, dosing funnel and gas bubbling inlet, 1020 parts of IPDI, 1.30 parts of di-butyl-tin-dilaurate and 4.00 parts of hydroquinone are loaded. Then 585 parts of hydroxypropylacrylate are dosed, avoiding that temperature increases to more than 50° C. Once addition is completed, 154 parts of glycerine are added. 15 minutes after the exothermic reaction subsides, the reaction product is cast on a metallic tray. The resulting urethane-acrylate is characterized by a GPC Mn of 744 and Mw of 1467, Tg (DSC) of 51° C., residual isocyanate content <0.1%, and theoretical unsaturation EQW of 392.

### Preparation of Epoxy-Acrylate Acceptor Resin

640 g bisphenol-A epoxy resin (Mn≈1075), 3.20 g 4-methoxyphenol (MEHQ), 3.20 g β-lonol and 4.73 g ethyltriphenylphosphonium bromide were charged into a 3 litre reaction vessel and heated to 135° C. with stirring. In a separate flask, 81.50 g acrylic acid was mixed with 0.08 g MEHQ and 0.03 g phenothiazine and then added into the reaction vessel over a period of 30 minutes. The reaction was allowed to proceed for another 5 hours at 130° C. until complete (AV=0). The final product has a GPC Mn of 1399, a Mw of 4956, a Tg (DSC) of 39° C. and theoretical unsaturation EQW of 637.

### Preparation of Carboxylate Terminated Retarder Resin

A 5 litre round bottom reactor equipped with a 4 necked lid, metal anchor stirrer, Pt-100, packed column with top thermometer, condenser, distillate collection vessel, thermocouple and a N2 inlet was charged with 1180 g NPG and 2000 g IPA. The temperature of the reactor was increased to 230° C., and the polymerization was progressed under nitrogen with continuous stirring until the reaction mixture is clear. The final product obtained has AV of 48 mg KOH/g and Tg (DSC) of 55° C.

### Preparation of Catalyst Precursor

To prepare the catalyst precursor, a carboxylate terminated polyester resin (AV of 48) was melted and mixed with an aqueous solution of tetraethylammonium bicarbonate TEAHCO₃ (41%) using a Leistritz ZSE 18 twin-screw extruder. The extruder comprised a barrel housing nine consecutive heating zones, that were set to maintain the following temperature profile 30-50-80-120-120-120-120-100-100 (in ° C.) from inlet to outlet. The solid polyester resin was added through first zone at a rate 2 kg/h, and liquid TEAHCO₃ was injected through second zone at 0.60 kg/h. Mixing was taken place between zone 4 to 7 and the screw was set to rotate at 200 rpm. Volatiles and water generated from acid-base neutralization was removed with assistance of vacuum at zone 7. The extruded strand was immediately cooled and collected after leaving the die. The final product obtained has AV of 11 mg KOH/g, amine value of 33 KOH/g and Tg (DSC) of 48° C.

### Preparation of Comparative (Semi) Crystalline Vinyl Ether Urethane Resin CVE-1

This component is described and made according to what is disclosed in CN112457751. 290 g 4-hydroxybutyl vinyl ether, 0.6 g dibutyl tin dilaurate (DBTL) and 0.2 g 2,5-di-tert-butyl-1,4-hydroquinone (BHT) were charged into a four-necked reactor provided with a thermometer, a stirrer and a distillation device. The mixture was stirred under a stream of oxygen and was heated to 40° C. 210 g hexamethylene-1,6-diisocyanate (HDI) was then slowly dropwise added into the reactor to start the reaction, and the process temperature was kept below 110° C. The reaction was allowed to be proceed for 30 minutes at 110° C. after charging all HDI. The (semi) crystalline vinyl ether CVE-1 obtained has a max and an end DSC melting temperature of 87° C. and 107° C. respectively. The theoretical unsaturation EQW=200 g/mol.

Loading Activator onto Precipitated Silica Carrier

175 g of HI-SIL® ABS-D precipitated silica (particle size=40 μm) was charged into a 5 litre reactor, equipped with a commercial stand mixer. The mixer was turned on to achieve steady state before 325 g of EPONEX® Resin 1510 was slowly added into the reactor. The mixture was left to stir until full homogenization was achieved and then discharged.

### Powder Coating Compositions and Powder Coating Component Compositions Preparations

To prepare the powder coating composition blend (PW1-2) or powder coating components (PWC3A & 3B, 4A & 4B, 5A, 6A, 7A, 8A & 8B, 9A & 9B), the raw materials were first premixed in a high speed Thermoprism Pilot Mixer 3 premixer at 1500 rpm for 20 seconds before being extruded in a Baker Perkins (formerly APV) MP19 25: 1 L D twin screw extruder. The extruder speed was 250 rpm and the four extruder barrel zone temperatures were set at 15, 25, 80 and 100° C.

Following extrusion, the extrudates were grinded using a Kemutec laboratory classifying microniser. The classifier was set at 5.5 rpm, the rotor was set at 7 rpm and the feed was set at 5.2 rpm. TGIC was grinded using a Retsch GRINDOMIX GM 200 knife mill. The grinded extrudates and TCIC were sieved to below 100 μm using Russel Finex 100-micron mesh Demi Finex laboratory vibrating sieves. Formulation compositions (as parts by weight) for PW1-2, PWC3, PWC4, PWC5, PWC6, PWC7, PWC8 and PWC9 are given in Table 1, 3, 8 and 10, 12 and 13 respectively.

### Results

PW1 and PW2 are comparative examples of powder coating compositions whereby all the compounds as listed in table 1 are extruded together.

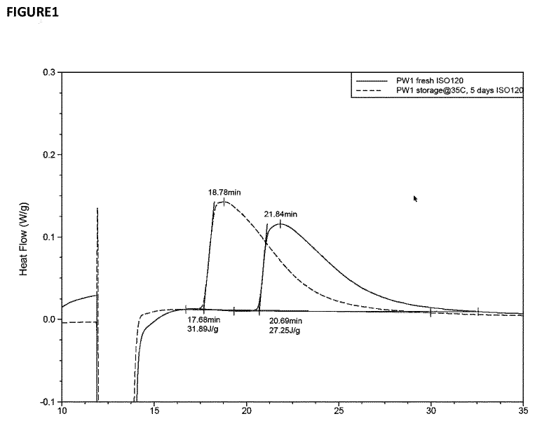

Comparative powder coating compositions PW1-PW2 were sprayed onto panels and cured for 20 minutes at 120° C. The MEK resistance, dry film thickness and 60° gloss level are summarized in Table 2. The kinetic profile of the freshly prepared composition and aged composition were measured by DSC using a 120° C. isothermal scan to determine the storage stability factor (SSF) and is illustrated in FIG. 1 for PW1. Some pre-mature reactions occurred during storage as the one set time of reaction exothermal starts earlier. The SSF for the two comparative examples are also summarized in Table 2.

TABLE 1
Comparative powder coating composition PW1-PW2

| | Comparative powder coating compositions | |
|---|---|---|
| | (values in parts by weight) | |
| | PW1 | PW2 |
| Malonate donor | 241 | 362 |
| Epoxy-acrylate acceptor | 271 | |
| Urethane-acrylate acceptor | | 214 |
| Catalyst precursor | 87 | 67 |
| Retarder resin | 40 | 30 |
| Araldite ® GT 7004 | 150 | 116 |
| Titanium dioxide Kronos | 200 | 200 |
| 2160 | | |
| Modaflow P6000 | 10 | 10 |
| Total | 1000 | 1000 |

TABLE 2
Summary of powder coating composition application
and storage results for PW1-PW2

| | PW1 | PW2 |
|---|---|---|
| MEK resistance (double rubs to rub through) | >50 | >50 |
| Film thickness DFT (μm) | 95 | 102 |
| Gloss at (60°) | 93 | 91 |
| Storage stability factor at 35° C., | 0.602 | 0.396 |
| average over 5 days (min/day) | | |

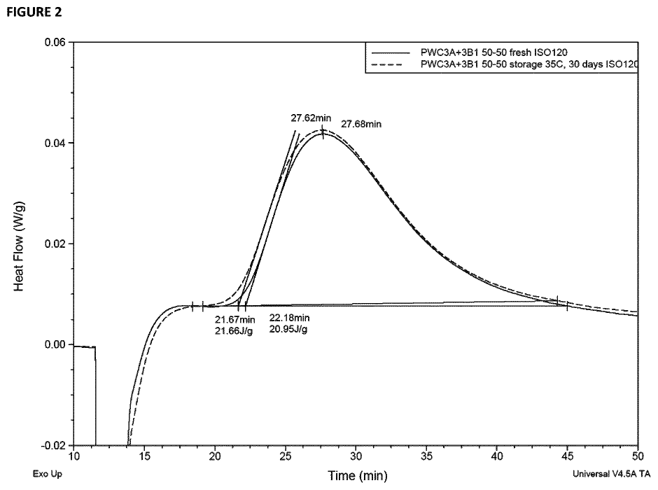

Four different Powder coating composition blends according to the invention are prepared by blending the powder coating component PWC3A with powder coating components PWC3B1, PWC3B2, PWCB3 or PWC3B4. The blends were sprayed onto panels and cured between 120-150° C. for 20 minutes using a gradient oven. In all cases, the coating gloss is much lower compared to the gloss in comparative example PW1. In addition, the kinetic profile of the freshly prepared blend and aged blend were measured by DSC using a 120° C. isothermal scan to determine the storage stability factor (SSF). FIG. 2 shows one example of such measurement for 50/50 blend of PWC3A+PWC3B1. The change of curing kinetic upon storage at 35° C. for 30 days is neglectable, as all values of SSF are close to zero (see table 4-7). As can be seen in the tables, all the coatings perform well in MEK resistance and have a reduced gloss.

TABLE 3
Powder coating components using epoxy-acrylate as acceptor. PWC3A =
precursor composition ; PWC3B = activator composition.

| | Powder coating components | | | | |
|---|---|---|---|---|---|
| | (values in parts by weight) | | | | |
| | PWC3A | PWC3B1 | PWC3B2 | PWC3B3 | PWC3B4 |
| Malonate donor | 299 | 238 | 218 | 259 | 327 |
| Epoxy-acrylate acceptor | 335 | 269 | 246 | 293 | 369 |
| Catalyst precursor | 156 | | | | |
| Retarder | | 44 | 88 | | 44 |
| Araldite ® GT 7004 | | 238 | 238 | 238 | |
| Araldite ® PT 912 | | | | | 49 |
| Titanium dioxide Kronos 2160 | 201 | 201 | 200 | 200 | 201 |
| Modaflow ® P6000 | 10 | 10 | 10 | 10 | 10 |
| Total (g) | 1000 | 1000 | 1000 | 1000 | 1000 |

TABLE 4
Summary of powder blends application and storage results for blend of
PWC3A + PWC3B1 at different ratios.

| Dry Blend | 30/70 | | 40/60 | | 50/50 | | 60/40 | | 70/30 | |
|---|---|---|---|---|---|---|---|---|---|---|
| Mix Ratio | | | | | | | | | | |
| (wt %/wt %) | | | | | | | | | | |
| (PWC3A/ | | | | | | | | | | |
| PWC3B1) | | | | | | | | | | |
| Curing | Gloss | 50 | Gloss | 50 | Gloss | 50 | Gloss | 50 | Gloss | 50 |
| (20 minutes | (60°) | MEK | (60°) | MEK | (60°) | MEK | (60°) | MEK | (60°) | MEK |
| @ ° C.) | | DB | | DB | | DB | | DB | | DB |
| 120 | 38 | 37 | 49 | >50 | 56 | >50 | 51 | 30 | 52 | >50 |
| 130 | 49 | >50 | 60 | >50 | 68 | >50 | 64 | >50 | 61 | >50 |
| 140 | 55 | >50 | 66 | >50 | 71 | >50 | 69 | >50 | 68 | >50 |
| 150 | 65 | >50 | 70 | >50 | 74 | >50 | 71 | >50 | 70 | >50 |
| SSF at 35° C., | <0.05 | | <0.05 | | <0.05 | | <0.05 | | <0.05 | |
| average over | | | | | | | | | | |
| 30 days | | | | | | | | | | |
| (mins/day) | | | | | | | | | | |

TABLE 5
Summary of powder blends application and storage results for blend of
PWC3A + PWC3B2 at different ratios.

| Dry Blend | 30/70 | | 40/60 | | 50/50 | | 60/40 | | 70/30 | |
|---|---|---|---|---|---|---|---|---|---|---|
| Mix Ratio | | | | | | | | | | |
| (PWC3A/ | | | | | | | | | | |
| PWC3B2) | | | | | | | | | | |
| Curing | Gloss | 50 | Gloss | 50 | Gloss | 50 | Gloss | 50 | Gloss | 50 |
| (20 minutes | (60°) | MEK | (60°) | MEK | (60°) | MEK | (60°) | MEK | (60°) | MEK |
| @ ° C.) | | DB | | DB | | DB | | DB | | DB |
| 120 | 44 | 25 | 46 | 33 | 51 | 30 | 51 | >50 | 51 | >50 |
| 130 | 49 | >50 | 59 | >50 | 67 | >50 | 68 | >50 | 60 | >50 |
| 140 | 64 | >50 | 69 | >50 | 70 | >50 | 75 | >50 | 69 | >50 |
| 150 | 67 | >50 | 68 | >50 | 75 | >50 | 77 | >50 | 71 | >50 |
| SSF at 35° C., | <0.05 | | <0.05 | | <0.05 | | <0.05 | | <0.05 | |
| average over | | | | | | | | | | |
| 30 days | | | | | | | | | | |
| (mins/day) | | | | | | | | | | |

TABLE 6
Summary of powder blends application and storage results for blend of
PWC3A + PWC3B3 at different ratios.

| Dry Blend | 30/70 | | 40/60 | | 50/50 | | 60/40 | | 70/30 | |
|---|---|---|---|---|---|---|---|---|---|---|
| Mix Ratio | | | | | | | | | | |
| (PWC3A/ | | | | | | | | | | |
| PWC3B3) | | | | | | | | | | |
| Curing | Gloss | 50 | Gloss | 50 | Gloss | 50 | Gloss | 50 | Gloss | 50 |
| (20 minutes | (60°) | MEK | (60°) | MEK | (60°) | MEK | (60°) | MEK | (60°) | MEK |
| @ ° C.) | | DB | | DB | | DB | | DB | | DB |
| (wt %/wt %) | | | | | | | | | | |
| 120 | 48 | >50 | 58 | >50 | 60 | >50 | 57 | >50 | 47 | >50 |
| 130 | 56 | >50 | 67 | >50 | 67 | >50 | 63 | >50 | 53 | >50 |
| 140 | 60 | >50 | 67 | >50 | 67 | >50 | 63 | >50 | 58 | >50 |
| 150 | 63 | >50 | 65 | >50 | 64 | >50 | 63 | >50 | 61 | >50 |

| | | | | | |
|---|---|---|---|---|---|
| SSF at 35° C., | <0.05 | <0.05 | <0.05 | <0.05 | <0.05 |

average over
30 days
(mins/day)

TABLE 7
Summary of powder blends application and storage results for blend of
PWC3A + PWC3B4 at different ratios.

| Dry Blend | 30/70 | | 40/60 | | 50/50 | | 60/40 | | 70/30 | |
|---|---|---|---|---|---|---|---|---|---|---|
| Mix Ratio | | | | | | | | | | |
| (wt %/wt %) | | | | | | | | | | |
| (PWC3A/ | | | | | | | | | | |
| PWC3B4) | | | | | | | | | | |
| Curing | Gloss | 50 | Gloss | 50 | Gloss | 50 | Gloss | 50 | Gloss | 50 |
| (20 minutes | (60°) | MEK | (60°) | MEK | (60°) | MEK | (60°) | MEK | (60°) | MEK |
| @ ° C.) | | DE | | DB | | DB | | DB | | DB |
| 120 | 42 | >50 | 49 | >50 | 58 | >50 | 60 | >50 | 56 | >50 |
| 130 | 46 | >50 | 52 | >50 | 59 | >50 | 61 | >50 | 61 | >50 |
| 140 | 45 | >50 | 52 | >50 | 57 | >50 | 60 | >50 | 61 | >50 |
| 150 | 48 | >50 | 55 | >50 | 61 | >50 | 61 | >50 | 63 | >50 |
| SSF at 35° C., | <0.05 | | <0.05 | | <0.05 | | <0.05 | | <0.05 | |
| average over | | | | | | | | | | |
| 30 days | | | | | | | | | | |
| (mins/day) | | | | | | | | | | |

PWC4A has been blended with PWC4B at different ratios to prepare powder coating composition blends according to the invention (Table 8). The blends were sprayed onto panels and cured between 120-150° C. for 20 minutes using a gradient oven. In all cases, the coating gloss is much lower compared to comparative example PW2. The kinetic profile of the freshly prepared blend and aged blend were measured by DSC using a 120° C. isothermal scan to determine the storage stability factor (SSF). The change of curing kinetic upon storage at 35° C. for 30 days is neglectable, as all values of SSF are close to zero (see table 9).

TABLE 8
Powder coating component compositions s using urethane-
acrylate as acceptor. PWC4A = precursor composition
; PWC4B = activator composition.

powder coating components
(values in parts by weight)

| | PWC4A | PWC4B |
|---|---|---|
| Malonate donor | 388 | 293 |
| Urethane-acrylate acceptor | 282 | 215 |
| Catalyst precursor | 119 | |
| Retarder | | 44 |
| Araldite ® GT 7004 | | 238 |
| Titanium dioxide Kronos 2160 | 201 | 200 |
| Modaflow ® P6000 | 10 | 10 |
| Total | 1000 | 1000 |

TABLE 9
Summary of powder coating blends application and storage results for the blend of
PW4A + PW4B at different ratios.

| Dry Blend | 30/70 | | 40/60 | | 50/50 | | 60/40 | | 70/30 | |
|---|---|---|---|---|---|---|---|---|---|---|
| Mix Ratio | | | | | | | | | | |
| wt %/wt % | | | | | | | | | | |
| (PWC4A/ | | | | | | | | | | |
| PWC4B) | | | | | | | | | | |
| Curing (20 | Gloss | 50 | Gloss | 50 | Gloss | 50 | Gloss | 50 | Gloss | 50 |
| minutes | (60°) | MEK | (60°) | MEK | (60°) | MEK | (60°) | MEK | (60°) | MEK |
| @ ° C.) | | DB | | DB | | DB | | DB | | DB |
| 120 | 42 | >50 | 45 | >50 | 44 | 37 | 44 | 30 | 40 | 31 |
| 130 | 46 | >50 | 57 | >50 | 54 | >50 | 52 | >50 | 46 | >50 |
| 140 | 45 | >50 | 64 | >50 | 57 | >50 | 54 | >50 | 45 | >50 |
| 150 | 48 | >50 | 74 | >50 | 66 | >50 | 55 | >50 | 39 | >50 |
| SSF at 35° C., | <0.05 | | <0.05 | | <0.05 | | <0.05 | | <0.05 | |
| average over | | | | | | | | | | |
| 30 days | | | | | | | | | | |
| (mins/day) | | | | | | | | | | |

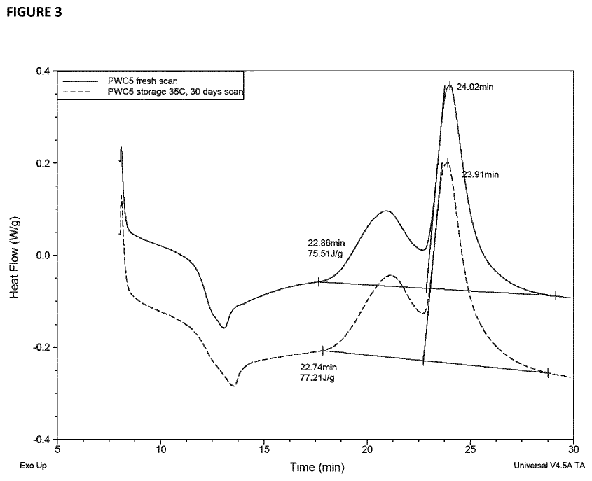

A 20/1 ratio of PWC5A and PWC5B (Table 10 for composition) were blended and applied as a powder coating composition blend onto panels by spraying. The blend was cured at 140° C. for 15 mins. Compared to example PW2, the gloss level is reduced to 43 GU at 60°. The kinetic profile of the freshly prepared blend and aged blend were measured by DSC using a temperature scan between 10-230° C., at a constant heating rate of 10° C./min. Replot the DSC curves enable determination of the storage stability factor (SSF), and it is illustrated in FIG. 3. The change of curing kinetic upon storage at 35° C. for 30 days is neglectable, as SSF is close to zero (Table 11).

TABLE 10
Powder component compositions. PWC5A = precursor
component; PWC5B = activator on a carrier.

| | Powder RMA Coating Example | |
|---|---|---|
| | (values in parts by weight) | |
| | PWC5A | PWC5B |
| Malonate donor | 537 | |
| Urethane-acrylate acceptor | 366 | |
| Catalyst precursor | 87 | |
| Silica carrier loaded with activator | | 1000 |
| Modaflow ® P6000 | 11 | |
| Total (g) | 1000 | 1000 |

TABLE 11
Summary of powder coating blend application and storage
results for blend of PW5A + PW5B at 20/1 ratio.

| | |
|---|---|
| Dry blend mix ratio (wt/wt) | 20/1 |
| (PWC5A / PWC5B) | |
| MEK resistance, 30 cycles (0-5, best to worst) | 2 |
| Film thickness DFT (μm) | 92 |
| Gloss at (60°) | 43 |
| SSF at 35° C., average over 30 days (mins/day) | <0.05 |

PWC6A and PWC7A are powder coating compositions with the compositions as given in table 12. These are prepared for making comparative powder coating composition blends PWS6 and PW7 which correspond to the powders disclosed in patent application with number CN112457751. PWC6A comprises CVE-1, which is a crystalline component used as plasticizer. PWC6A and PWC7A do not contain any activator component. Powder coating composition blends PW6 and PW7 are made by blending PWC6A (average particle size 38 um) and PWC7A (average particle size 31 um) respectively, with grinded TGIC powder (average particle size 21 um) which is the activator component according to a ratio of 98:2. We herewith note that in CN112457751 a ratio of 94:6 is used. However, to be comparative with the examples according to the invention herewith provided, a lower amount of TGIC is used. PW6 and PW7 were each sprayed onto aluminum Q-panels and cured for 20 minutes at 100° C.

TABLE 12
Comparative powder coating components PWC6A and PWC7A

| | Comparative powder coating compositions | |
|---|---|---|
| | (values in parts by weight) | |
| | PWC6A | PWC7A |
| Malonate donor | 415 | 503 |
| Crystalline vinyl ether | 104 | |
| (CVE-1) | | |
| Urethane-acrylate acceptor | 369 | 366 |
| Catalyst precursor | 102 | 84 |
| Retarder resin | | 37 |
| Modaflow P6000 | 10 | 10 |
| Total | 1000 | 1000 |

TABLE 13
Powder coating components composition
PWC8A, PWC8B, PWC9A and PWC9B

| | Powder coating components | | | |
|---|---|---|---|---|
| | (values in parts by weight) | | | |
| | PWC8A | PWC8B | PWC9A | PWC9B |
| Malonate donor | 376 | 442 | 461 | 525 |
| Crystalline vinyl ether (CVE-1) | 94 | 111 | 336 | 382 |
| Urethane-acrylate acceptor | 334 | 392 | | |
| Catalyst precursor | 186 | | 158 | |
| Retarder | | | 35 | 40 |
| TGIC | | 45 | | 43 |
| Modaflow ® P6000 | 10 | 10 | 10 | 10 |
| Total | 1000 | 1000 | 1000 | 1000 |

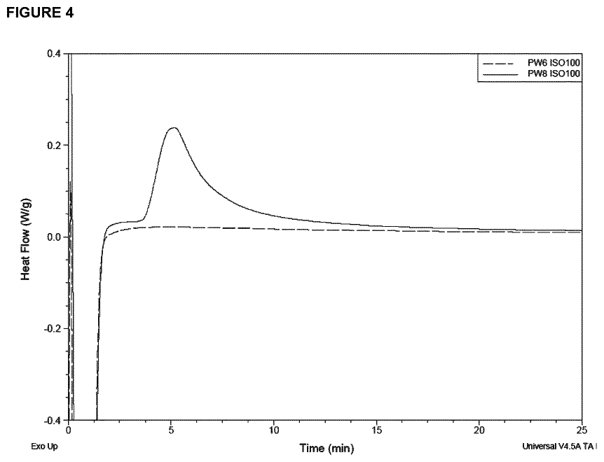

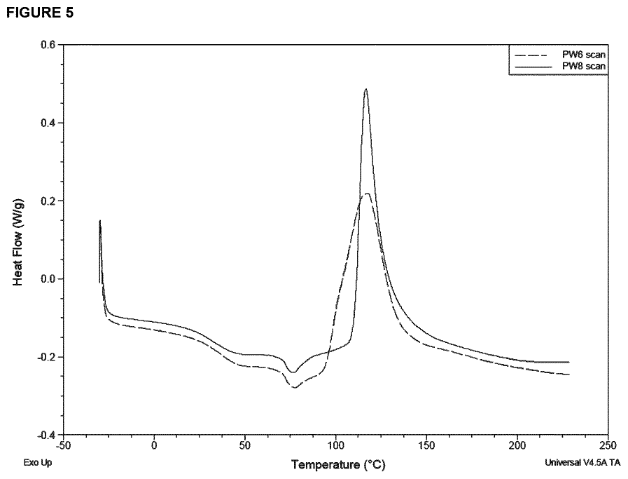

A powder coating composition blend according to the invention PW8 was prepared by blending a precursor powder coating component PWC8A (average particle size 36 um), and an activator powder coating component PWC9B (average particle size 36 um) in a ratio of 54/46. The overall composition of this powder coating blend is identical to the comparative powder coating blend of PW6, in view of the relative amount of donor/acceptor ratio, catalyst precursor concentration and activator concentration. The blend according to invention was sprayed onto aluminum Q-panels panels and cured for 20 minutes at 100° C. Compared to comparative powder coating blend PW6, the coating blend according to invention PW8 achieves better solvent resistance and has a lower gloss level. These application results are summarized in Table 14. FIG. 4 shows the DSC isothermal analysis at 100° C. for both powder coating blends composition PW6 and PW8. It is clear that no reaction exothermic peak can be observed for PW6, indicating no or very little curing has occurred at 100° C. In addition, DSC temperature scan analyses of both powder coating blend (see FIG. 5) suggests a faster curing speed for PW8 compared to PW6, as one set of curing start at lower temperature and the reaction also completes earlier.

Similarly, a powder coating composition blend PW9 according to the invention was prepared by blending a precursor composition PWC9A (average particle size 34 um), and an activator composition PWC9B (average particle size 34 um) in a ratio of 53/47 (see table 13). The overall composition of this powder coating blend is identical to the comparative powder coating blend of PW7, in view of the relative amounts of donor/acceptor ratio, catalyst precursor concentration and activator concentration. The blend according to invention was sprayed onto aluminum Q-panels panels and cured for 20 minutes at 120° C. Compared to comparative powder coating blend PW7, the coating blend according to invention PW9 achieves better solvent resistance and has a lower gloss level. These application results are summarized in Table 14.

Use of pure TGIC grinded to a fine powder will create significant risks of exposure of application workers to fine particles of pure TGIC through inhalation or skin contact. TGIC carries significant health hazards, it is known to be mutagenic (hazard statement H340), toxic by inhalation (H331), strongly sensitizing through skin contact (H317), and causing organ damage upon repeated exposure (H373). TGIC has been listed in Europe as a Substance of Very High Concern (SVHC), and for the above reasons essentially banned from use in powder coatings there. Use of fine particles of pure TGIC at the paint application stage can be considered to introduce extra health risks, beyond its application as minority component in extrusion formulating powder paint compositions.

TABLE 14
Summary of powder coating blends application results for the comparative powder
blend of PW6, PW7, and corresponding inventive powder blend of PW8 and PW9.

| | Dry blend mix ratio (wt %/wt %) | | | |
|---|---|---|---|---|
| | PWC6A/TGIC | PWC7A/TGIC | PWC8A/PWC8B | PWC9A/PWC9B |
| | (98/2) (PW6) | (98/2) (PW7) | (54/46) (PW8) | (53/47) (PW9) |
| MEK resistance (0-5, best to worst) | 4 | 5 | 2 | 3 |
| Dry film thickness DFT (μm) | 70-90 | 70-90 | 70-90 | 70-90 |
| Gloss at (60°) | 67 | 47 | 38 | 28 |

1. A powder coating composition blend comprising a crosslinkable composition and a catalyst system, wherein the crosslinkable composition is formed by a crosslinkable donor component A and a crosslinkable acceptor component B that are crosslinkable by a Real Michael Addition (RMA) reaction via the catalyst system, and which catalyst system is able to catalyze the RMA crosslinking reaction at a curing temperature below 200° C., preferably below 175° C., more preferably below 150° C., 140, 130 or even 120° C. and preferably at least 70° C., preferably at least 80, 90 or 100° C.,
wherein the crosslinkable composition comprises
a) the crosslinkable donor component A having at least 2 acidic C—H donor groups in activated methylene or methine, and
b) the crosslinkable acceptor component B having at least 2 activated unsaturated acceptor groups C═C, which react with component A by Real Michael Addition (RMA) to form a crosslinked network,
and
wherein the catalyst system is a separated catalyst system that comprises a catalyst precursor composition (P) and a catalyst activator composition (C) that are macrophysically separated;
wherein
the catalyst precursor composition (P) comprising a catalyst precursor P1; and
the catalyst activator composition (C) comprising a catalyst activator C1;
or
wherein the crosslinkable donor component A and the crosslinkable acceptor component B are macrophysically separated; and the catalyst system is
a latent catalyst system comprising the catalyst precursor P1 and the catalyst activator C1; or
a non-latent catalyst system comprising a strong base;
wherein the catalyst precursor P1 is a weak base with a pKa of its protonated form of more than 2, preferably more than 3, more preferably more than 4 and even more preferably at least 5 units lower than that of the activated C—H groups in donor component A; and the catalyst activator C1 can react with P1 at curing temperature, producing a strong base (C1P1) that can catalyze the Michael Addition reaction between A and B.

2. The powder coating composition blend according to claim 1, wherein the separated catalyst system further comprise a retarder T which is and acid that has a pKa of more than 2 more preferably more than 3, even more preferably more than 4 or 5 points lower than that of the activated C—H in A, and which upon deprotonation produces a weak base that can react with the activator C1, producing a strong base that can catalyse the Michael Addition reaction between the crosslinkable compositions A and B.

3. The powder coating composition blend according to claim 1, wherein the powder coating composition blend is prepared by
melt-mixing components A and/or B of the crosslinkable composition with the catalyst precursor composition (P) and optionally the retarder T to obtain a precursor extrudate;
melt-mixing components A and/or B of the crosslinkable composition with the catalyst activator composition (C) and optionally the retarder T to obtain an activator extrudate;
solidifying and granulating the precursor extrudate and activator extrudate to obtain a precursor powder composition and an activator powder composition;
dry blending the precursor and activator powder compositions to obtain the powder coating composition blend.

4. The powder coating composition blend according to claim 1, wherein the powder coating composition blend is prepared by
melt-mixing the crosslinkable component A to obtain a donor extrudate and/or the crosslinkable component B to obtain an acceptor extrudate, whereby the crosslinkable component A and/or B is melt-mixed with the latent or the non-latent catalyst system;
solidifying and granulating the donor and/or the acceptor extrudate to obtain a donor powder composition and/or an acceptor powder composition;
dry blending the donor powder composition and acceptor powder composition in case both the component A and B have been melt mixed; or dry blending the donor powder composition or the acceptor powder composition with the crosslinkable component B or A that have a grindable solid form, respectively, in case only component A or B has been melt mixed, to obtain the powder coating composition blend.

5. The powder coating composition blend according to claim 1, wherein the catalyst activator composition (C) comprises
a catalyst activator C1 residing on a carrier in case the catalyst activator C1 is liquid; or wherein the catalyst precursor composition (P) comprises
a catalyst precursor P1 residing on a carrier in case the catalyst precursor is liquid; or wherein the carrier preferably has a particle size (defined as Dᵥ⁵⁰) of between 5 and 200 μm, more preferably between 10 and 150 μm, even more preferably between 10 and 100 μm, and most preferably between 15 and 50 μm.

6. The powder coating composition blend according to claim 5, wherein the powder coating composition blend is prepared by
melt-mixing components A and B of the crosslinkable composition with the catalyst precursor composition (P) and optionally the retarder T to obtain a precursor extrudate;
solidifying and granulating the precursor extrudate to obtain a precursor powder composition;
dry blending the precursor powder composition with an activator residing on a carrier to obtain the powder coating composition blend; or
melt-mixing components A and B of the crosslinkable composition with the catalyst activator composition (C) and optionally the retarder T to obtain an activator extrudate;
solidifying and granulating the activator extrudate to obtain an activator powder composition;
dry blending the activator extrudate with a precursor residing on a carrier to obtain the powder coating composition blend.

7. The powder coating composition blend according to claim 3, wherein the precursor powder composition, activator powder composition, the donor powder composition and acceptor powder composition have a particle size defined as Dᵥ⁵⁰ of maximum 200 μm, more preferably maximum 150 μm, more preferable no more than 100 μm and most preferably less than 50 μm.

8. The powder coating composition blend according to claim 3, wherein the mass ratio (wt %/wt %) of the precursor powder composition and activator powder composition or the donor powder composition and acceptor powder composition used for dry blending and obtaining the powder coating composition blend is between 20 and 0.05, more preferably between 10 and 0.1, even more preferably between 5 and 0.2 and most preferably between 2 and 0.5; or
wherein the component is a catalyst precursor or activator residing on a carrier is present in and amount of between 1 and 30 wt %, preferably between 3 and 20 wt %, more preferably between 4 and 15 wt % in view of the total powder composition blend.

9. The powder coating composition blend according to claim 1, wherein in the separated catalyst system
the activator C1 is selected from the group of epoxide, carbodiimide, oxetane, oxazoline or aziridine functional components, preferably an epoxide or carbodiimide; and
the catalyst precursor P1 is a weak base nucleophile anion chosen from the group carboxylate, phosphonate, sulphonate, halogenide or phenolate anions or a non-ionic nucleophile, preferably a tertiary amine, or phosphine; more preferably a weak base nucleophile anion chosen from the group carboxylate, halogenide or phenolate anions or 1,4-diazabicyclo-[2.2.2]-octane (DABCO) or an N-alkylimidazole, most preferably a carboxylate, and/or
the retarder T which is preferably a protonated precursor P1.

10. The powder coating composition blend according to claim 1, wherein in the catalyst system
the activator C1 is a Michael acceptor comprising an activated unsaturated group C═C reactive with P1, preferably and acrylate, methacrylate, fumarate, itaconate or maleate; and
the catalyst precursor P1 is a weak base selected from the group of phosphines, N-alkylimidazoles and fluorides or is a weak base nucleophile anion X⁻ from an acidic X—H group containing compound wherein X is N, P, O, S or C, wherein anion X⁻ is a Michael Addition donor reactive with activator C1; and/or
retarder T, which is preferably a protonated precursor P1.

11. The powder coating composition blend according to claim 1, wherein the catalyst precursor P1 is added as a salt comprising a cation that is not acidic, preferably a cation according to formula Y(R′)₄, wherein Y represents N or P, and wherein each R′ can be a same or different alkyl, aryl or aralkyl group possibly linked to a polymer or wherein the cation is a protonated very strong basic amine, which very strong basic amine is preferably selected from the group of amidines; preferably 1,8-diazabicyclo (5.4.0)undec-7-ene (DBU), or guanidines; preferably 1,1,3,3-tetramethylguanidine (TMG).

12. The powder coating composition blend according to claim 1, comprising
an activator C1 in an amount between 1 and 600 μeq/gr, preferably between 10 and 400, more preferably between 20 and 200 μeq/gr relative to total weight of binder components A and B and the separated catalyst system,
a. a precursor P1 in an amount between 1 and 300 μeq/gr, preferably between 10 and 200, more preferably between 20 and 100 μeq/gr relative to total weight of binder components A and B and the separated catalyst system,
b. optionally a retarder T in an amount between 1 and 500, preferably between 10 and 400, more preferably between 20 and 300 μeq/gr and most preferably between 30 and 200 μeq/gr, relative to total weight of binder components A and B and the separated catalyst system
c. preferably wherein the equivalent amount of C1
i. is higher than the amount of T, when present, preferably by an amount between 1 and 300 μeq/gr, preferably between 10 and 200, more preferably between 20 and 100 μeq/gr and
ii. is preferably higher than the amount of P1 and
iii. more preferably higher than the sum of the amount of P1 and T.

13. The powder coating composition blend according to claim 1,
a. wherein the weak base P1 respectively represents between 10 and 100 equivalent % of the sum of P1 and T,
b. preferably the amount of retarder T is 20-400 eq %, preferably 30-300 eq % of the amount of P1,
c. wherein preferably the ratio of the equivalent amount of C1 to the sum of the amount of P1 and Tis at least 0.5, preferably at least 0.8, more preferably at least 1 and preferably at most 3, more preferably at most 2,
d. the ratio of C1 to T is preferably at least 1, preferably at least 1.5, most preferably at least 2.

14. The powder coating composition blend according to claim 1, wherein
a. crosslinkable component A comprises at least 2 acidic C—H donor groups in activated methylene or methine in a structure Z1(—C(—H)(—R)—)Z2 wherein R is hydrogen, a hydrocarbon, an oligomer or a polymer, and wherein Z1 and Z2 are the same or different electron-withdrawing groups, preferably chosen from keto, ester or cyano or aryl groups, and preferably comprises an activated C—H derivative having a structure according to formula 1: 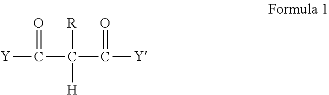
wherein R is hydrogen or an optionally substituted alkyl or aryl and Y and Y′ are identical or different substituent groups, preferably alkyl, aralkyl or aryl, or alkoxy or wherein in formula 1 the —C(═O)—Y and/or —C(═O)—Y′ is replaced by CN or aryl, no more than one aryl or wherein Y or Y′ can be NRR′ (R and R′ are H or optionally substituted alkyl) but preferably not both, wherein R, Y or Y′ optionally provide connection to an oligomer or polymer, said component A preferably being a malonate, acetoacetate, malonamide, acetoacetamide or cyanoacetate groups, preferably providing at least 50, preferably 60, 70 or even 80% of the total of C—H acidic groups in crosslinkable component A,
b. Component B comprises the at least 2 activated unsaturated RMA acceptor groups preferably originate from acryloyl, methacryloyl, itaconates, maleate or fumarate functional groups,
wherein preferably at least one, more preferably both, of components A or B is a polymer and
wherein preferably the composition comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

15. The powder coating composition blend according to claim 1, wherein at least one of crosslinkable components A or B or hybrid A/B is a polymer, preferably chosen from the group of acrylic, polyester, polyester amide, polyester-urethane polymers, which polymer
has a number average molecular weight Mn, as determined with GPC, of at least 450 gr/mole, preferably at least 1000, more preferably at least 1500 and most preferably at least 2000 gr/mole;
has a weight average molecular weight Mw, as determined with GPC, of at most 20000 gr/mole, preferably at most 15000, more preferably at most 10000 and most preferably at most 7500 gr/mole;
preferably has a polydispersity Mw/Mn below 4, more preferably below 3;
has an equivalent weight EQW in C—H or C═C of at least 150, 250, 350, 450 or 550 gr/mole and preferably at most 2500, 2000, 1500, 1250 or 1000 gr/mole and a number average functionality of reactive groups C—H or C═C between 1-25, more preferably 1.5-15 even more preferably 2-15, most preferably 2.5-10 C—H groups per molecule;
preferably has a melt viscosity at a temperature in the range between 100 and 140° C. less than 60 Pas, more preferably less than 40, 30, 20, 10 or even 5 Pas;
preferably comprises amide, urea or urethane bonds and/or comprises high Tg monomers, preferably cycloaliphatic or aromatic monomers, in particular polyester monomers chosen from the group of 1,4-dimethylol cyclohexane (CHDM), tricyclodecanedimethanol (TCD diol), isosorbide, penta-spiroglycol or hydrogenated bisphenol A and tetramethyl-cyclobutanediol; and/or
has a Tg above 25° C., preferably above 35° C., more preferably above 40, 50 or even 60° C. as as the midpoint value determined by DSC at a heating rate of 10° C./min or is a crystalline polymer with a melting temperature between 40° C. and 150, preferably 130° C., preferably at least 50 or even 70° C. and preferably lower than 120° C. (as determined by DSC at a heating rate of 10° C./min).

16. The powder coating composition blend according to claim 1, wherein component B is a polyester (meth-)acrylate, a polyester urethane (meth-)acrylate, an epoxy (meth-) acrylate or a urethane (meth-)acrylate, or is a polyester comprising fumarate, maleate or itaconate units, preferably fumarate or is a polyester end-capped with isocyanate or epoxy functional activated unsaturated group.

17. A method for powder-coating a substrate comprising
a. applying a layer comprising the powder coating composition blend according to claim 1, to a substrate surface wherein the substrate preferably is a temperature sensitive substrate, preferably MDF, wood, plastic, composite or temperature sensitive metal substrates like alloys and
b. heating to a curing temperature Tcur between 75 and 200° C., preferably between 80 and 180° C. and more preferably between 80 and 160, 150, 140, 130 or even 120° C., preferably using infrared heating, wherein the melt viscosity at the curing temperature Tour is preferably less than 60 Pas, more preferably less than 40, 30, 20, 10 or even 5 Pas;
c. and curing at Tour for a curing time preferably less than 40, 30, 20, 15, 10 or even 5 minutes.

18. Articles coated with a powder having a the powder coating composition blend according to claim 1, wherein the articles preferably have a temperature sensitive substrate preferably selected from the group of MDF, wood, plastic or metal alloys and wherein preferably the crosslinking density XLD is at least 0.01, preferably at least 0.02, 0.04, 0.07 or even 0.1 mmol/ml (as determined by DMTA) and is preferably lower than 3, 2, 1.5, 1 or even 0.7 mmol.
